(19) United States
(12) Patent Application Publication
(10) Pub. No.: US 2008/0224546 A1
(43) Pub. Date: Sep. 18, 2008

(54) METHOD TO ANALYZE SYSTEM RECONFIGURATION FOR AUTOMATED ISOLATION OF DISTURBANCES TO THE POWER DISTRIBUTION SYSTEM

(76) Inventors: John Arthur TeSelle, Massillon, OH (US); Douglas Martin Johns, Penn Run, PA (US)

Correspondence Address: BROUSE MCDOWELL LPA, 388 SOUTH MAIN STREET, SUITE 500, AKRON, OH, 44311, US

(21) Appl. No.: 12/054,967

(22) Filed: Mar. 25, 2008

Related U.S. Application Data
(63) Continuation-in-part of application No. 11/945,783, filed on Nov. 27, 2007.
(60) Provisional application No. 60/861,343, filed on Nov. 27, 2006.

(51) Int. Cl. H02B 1/24

(52) U.S. Cl. 307/125

(57) ABSTRACT

A method and system where, by tabulating the known values and parameters of a distribution system and its automated equipment in a specific manner, the automated system reconfiguration can quickly identify and thereby implement the optimal system reconfiguration for service restoration.

This invention is a continuation-in-part and claims priority to U.S. Ser. No. 11/945,783 titled Method and System for Isolating Disturbances to the Power Distribution System, filed Nov. 27, 2007, which is hereby incorporated by reference, which claims priority to U.S. Ser. No. 60/861,343 titled Method and System for Isolating Disturbances to the Power Distribution System, filed Nov. 27, 2006.

### I. BACKGROUND

The present invention is directed generally to a method to analyze the best reconfiguration of an electric distribution system equipped with automation, and with a suitable topology, that will first isolate a fault or loss-of-voltage type of system disturbance and second switch as much of the unaffected portions of the system to other sources of electric supply as possible.

An electric utility's distribution system is that part of the electric grid that transports electricity from the higher voltage transmission or sub-transmission system and delivers it to the electricity consumer. The delineation point between the distribution system and the transmission or sub-transmission system is a substation.

Generally, there are two basic distribution system configurations: interconnected and radial. An interconnected distribution system comprises a configuration where there are generally two or more sources of electricity supply to the consumer. A radial distribution system comprises a configuration where the distribution system is operated with a single source of electricity supply to a distribution system circuit.

It is known that in a radial distribution system entire circuits or circuit segments may be switched from one source to another. However, any resulting configuration continues to comprise only a single source of electricity supply to the distribution system. Several circumstances may arise that require a circuit or circuit segment to be switched from one source to another. For example, the distribution system may need to be reconfigured to restore service to part of the distribution system following a disturbance such as a fault or loss of voltage.

It is known to utilize a zoned or tiered structure of protective measures to provide a radial distribution system with several layers of protection. Protection devices generally fall into two functional categories: single operation devices and multi-operation devices. Single operation devices comprise devices that operate to destruction, such as a fuse. Multi-operation devices comprise devices that are capable of operating one or more times for a single disturbance, such as a breaker and a recloser. The multiple operations of reclosers and breakers allow temporary faults to clear and service to be restored within minutes for a fault that is cleared prior to the end of their operation. For a persistent fault a multi-operation device will proceed through their sequence of operations and remain open upon the completion of that sequence. When a multi-operation device proceeds through its sequence of operations and remains open, the multi-operation device is said to have operated to “lock-out.”

It is known to utilize fuses as the first and most extensively applied protection device. Fuses are generally located on circuit taps where, due to topology, alternate sources of electricity supply are not available. Reclosers may be placed in the main trunk of the circuit. When used in conjunction with fuses, reclosers may provide a second layer of protection to the distribution system. Additionally, breakers may provide a third layer of protection and are generally placed at the substation between the substation transformer and the circuit.

A first type of disturbance is a fault disturbance or an over-current condition where the current flowing through the distribution system exceeds a threshold level. Conventionally, in a properly coordinated protection scheme, upon the occurrence of a fault disturbance, the protective device that is closest to and upstream of the fault will operate thereby isolating the fault disturbance from the balance of the distribution system. In this case, the portion of the circuit downstream of the protective device that operated to isolate the fault disturbance remains de-energized (i.e., out of service) until repairs are affected and the protective device can be placed back in service. Even if otherwise unaffected, a downstream section of the circuit can be isolated from the fault disturbance through a switching action. If an alternate electricity source is not available, these downstream sections remain de-energized. The upstream direction, or upstream, refers to the direction moving towards the electricity source. The downstream direction, or downstream, refers to the direction moving away from the electricity source.

A second type of disturbance is a loss-of-voltage event. A loss of electricity supply in either the transmission system or substation, or when there is an undesired open in the distribution system that is undetected by the protection scheme may cause a loss-of-voltage event. A third type of disturbance is an overload event. An overload event may occur when a protective device operates to prevent the overloading of substation equipment or the mainline conductor.

What is needed then is a method for analyzing system reconfiguration for automated isolation of disturbances to an electric distribution system that will: (1) isolate a fault or loss-of-voltage disturbance within the electric distribution system; (2) analyze the best reconfiguration of the electric distribution system; and, (3) reconfigure the electric distribution system to switch portions of the electric distribution system that are otherwise unaffected by the disturbance to alternate sources of electric supply where possible.

### II. SUMMARY

According to one embodiment of the invention, a method for analyzing system reconfiguration for automated isolation of disturbances to a power distribution system may comprise the steps of:

(a) providing an automated reconfiguration system for analyzing system reconfiguration for automated isolation of disturbances to a power distribution system;

(b) detecting a triggering event, wherein the triggering event may indicate a disturbance within the power distribution system;

(c) scanning at least a first circuit of the power distribution system to update a predetermined set of data relating to a plurality of controlled devices located within the first circuit, wherein the first circuit may comprise at least a first circuit path;

(d) autonomously updating at least a first table, wherein the first table may comprise data associated with the first circuit path and the first table may comprise a plurality of sets of rows, wherein the plurality of sets of rows may be arranged to form a plurality of sets of columns, wherein each set of columns may comprise at least a first set of rows and a second set of rows,
wherein the first set of rows may comprise a plurality of device rows and each of the plurality of device rows may comprise data relating to one of the controlled devices located on the first circuit path of the first circuit and the plurality of device rows may be arranged in a sequential manner beginning with a normally open point and proceeding upstream to a source of supply, wherein a first binary indicator may be used to indicate the status of each of the controlled devices;
wherein the second set of rows may comprise a single row comprising data indicating the status of the first circuit path and a second binary indicator may be used to indicate the status of the first circuit path;

(e) determining a type of disturbance comprised by the disturbance, wherein the type of disturbance may be at least partially determined by analyzing the first table;

(f) determining a circuit segment comprising the disturbance wherein the circuit segment comprising the disturbance may be at least partially determined by analyzing the first table;

(g) isolating the disturbance;

(h) determining a non-energized non-faulted portion of the circuit segment;

(i) identifying an alternate source of electric supply;

(j) terminating the method if the alternate source of electric supply is determined to be unavailable to energize the non-energized non-faulted portion of the circuit segment; and,

(k) reconfiguring the power distribution system if the alternate source of electric supply is determined to be available, wherein the power distribution system is reconfigured such that the non-energized non-faulted portion of the circuit segment is energized by the alternate source of electric supply.

According to another embodiment of the invention, a method for analyzing system reconfiguration for automated isolation of disturbances to a power distribution system may comprise the steps of:

(a) providing an automated reconfiguration system for analyzing system reconfiguration for automated isolation of disturbances to a power distribution system;

(b) detecting a triggering event, wherein the triggering event may indicate a disturbance within the power distribution system;

(c) scanning at least a first circuit of the power distribution system to update a predetermined set of data relating to a plurality of controlled devices located within the first circuit, wherein the first circuit may comprise at least a first circuit path;

(d) autonomously updating at least a first table, wherein the first table may comprise data associated with the first circuit path and the first table may comprise a plurality of sets of rows, wherein the plurality of sets of rows are arranged to form a plurality of sets of columns, wherein each set of columns may comprise at least a first set of rows and a second set of rows,
wherein the first set of rows may comprise a plurality of device rows and each of the plurality of device rows comprise data relating to one of the controlled devices located on the first circuit path of the first circuit and the plurality of device rows may be arranged in a sequential manner beginning with a normally open point and proceeding upstream to a source of supply, wherein a first binary indicator may be used to indicate the status of each of the controlled devices;
wherein the second set of rows may comprise a single row comprising data indicating the status of the first circuit path and a second binary indicator may be used to indicate the status of the first circuit path;

autonomously updating the first table, wherein the first table may comprise a first set of columns comprising a first column, a second column, and a third column, wherein the first column can be analyzed to indicate the type of disturbance as a fault disturbance, the second column can be analyzed to indicate the type of disturbance as a loss-of-voltage, and the third column can be analyzed to indicate the type of disturbance as an overload condition;

(e) determining a type of disturbance comprised by the disturbance, wherein the type of disturbance may be at least partially determined by analyzing the first table;

(f) determining a circuit segment comprising the disturbance wherein the circuit segment comprising the disturbance may be at least partially determined by analyzing the first table;

(g) isolating the disturbance;

(h) determining a non-energized non-faulted portion of the circuit segment;

(i) identifying an alternate source of electric supply;

(j) terminating the method if the alternate source of electric supply is determined to be unavailable to energize the non-energized non-faulted portion of the circuit segment; and,

(k) reconfiguring the power distribution system if the alternate source of electric supply is determined to be available, wherein the power distribution system is reconfigured such that the non-energized non-faulted portion of the circuit segment is energized by the alternate source of electric supply.

According to another embodiment of the invention, a method for analyzing system reconfiguration for automated isolation of disturbances to a power distribution system may comprise the steps of:

(a) providing an automated reconfiguration system for analyzing system reconfiguration for automated isolation of disturbances to a power distribution system;

(b) detecting a triggering event, wherein the triggering event may indicate a disturbance within the power distribution system;

(c) scanning at least a first circuit of the power distribution system to update a predetermined set of data relating to a plurality of controlled devices located within the first circuit, wherein the first circuit may comprise at least a first circuit path;

(d) autonomously updating at least a first table, wherein the first table may comprise data associated with the first circuit path and the first table may comprise a plurality of sets of rows, wherein the plurality of sets of rows are arranged to form a plurality of sets of columns, wherein each set of columns may comprise at least a first set of rows and a second set of rows,
wherein the first set of rows may comprise a plurality of device rows and each of the plurality of device rows may comprise data relating to one of the controlled devices located on the first circuit path of the first circuit and the plurality of device rows may be arranged in a sequential manner beginning with a normally open point and proceeding upstream to a source of supply, wherein a first binary indicator may be used to indicate the status of each of the controlled devices;
wherein the second set of rows may comprise a single row comprising data indicating the status of the first circuit path and a second binary indicator may be used to indicate the status of the first circuit path;

autonomously updating the first table, wherein the plurality of sets of columns of the first table may comprise a first set of columns and a second set of columns,
wherein the first set of columns may comprise a first column, a second column, and a third column, wherein the first column can be analyzed to indicate the type of disturbance as a fault disturbance, the second column can be analyzed to indicate the type of disturbance as a loss-of-voltage, and the third column can be analyzed to indicate the type of disturbance as an overload condition; and,
the second set of columns may comprise at least a first column that comprises a first binary indicator indicating whether each of the plurality of controlled devices comprise a nominal position, wherein the nominal position of the normally open point may be open and the nominal position of the remaining devices comprising the plurality of controlled devices may be closed;

(e) determining a type of disturbance comprised by the disturbance, wherein the type of disturbance may be at least partially determined by analyzing the first table;

(f) determining a circuit segment comprising the disturbance wherein the circuit segment comprising the disturbance may be at least partially determined by analyzing the first table;

(g) isolating the disturbance;

(h) determining a non-energized non-faulted portion of the circuit segment;

(i) identifying an alternate source of electric supply;

(j) terminating the method if the alternate source of electric supply is determined to be unavailable to energize the non-energized non-faulted portion of the circuit segment; and,

(k) reconfiguring the power distribution system if the alternate source of electric supply is determined to be available, wherein the power distribution system is reconfigured such that the non-energized non-faulted portion of the circuit segment is energized by the alternate source of electric supply.

According to another embodiment of the invention, a method for analyzing system reconfiguration for automated isolation of disturbances to a power distribution system may comprise the steps of:

(a) providing an automated reconfiguration system for analyzing system reconfiguration for automated isolation of disturbances to a power distribution system;

(b) detecting a triggering event, wherein the triggering event may indicate a disturbance within the power distribution system;

(c) scanning at least a first circuit of the power distribution system to update a predetermined set of data relating to a plurality of controlled devices located within the first circuit, wherein the first circuit may comprise at least a first circuit path;

(d) autonomously updating at least a first table, wherein the first table may comprise data associated with the first circuit path and the first table may comprise a plurality of sets of rows, wherein the plurality of sets of rows may be arranged to form a plurality of sets of columns, wherein each set of columns may comprise at least a first set of rows and a second set of rows,
wherein the first set of rows may comprise a plurality of device rows and each of the plurality of device rows may comprise data relating to one of the controlled devices located on the first circuit path of the first circuit and the plurality of device rows may be arranged in a sequential manner beginning with a normally open point and proceeding upstream to a source of supply, wherein a first binary indicator may be used to indicate the status of each of the controlled devices;
wherein the second set of rows may comprise a single row comprising data indicating the status of the first circuit path and a second binary indicator may be used to indicate the status of the first circuit path;
wherein the plurality of sets of columns may comprise a first set of columns;

(e) determining a type of disturbance comprised by the disturbance, wherein the type of disturbance may be at least partially determined by analyzing the first table;

scanning the second set of rows of the first set of columns for a non-zero binary indicator;

(f) determining a circuit segment comprising the disturbance wherein the circuit segment comprising the disturbance may be at least partially determined by analyzing the first table;

(g) isolating the disturbance;

(h) determining a non-energized non-faulted portion of the circuit segment;

(i) identifying an alternate source of electric supply;

(j) terminating the method if the alternate source of electric supply is determined to be unavailable to energize the non-energized non-faulted portion of the circuit segment; and, (k) reconfiguring the power distribution system if the alternate source of electric supply is determined to be available, wherein the power distribution system is reconfigured such that the non-energized non-faulted portion of the circuit segment is energized by the alternate source of electric supply.

According to one embodiment of the invention, a method for analyzing system reconfiguration for automated isolation of disturbances to a power distribution system may comprise the steps of:

(a) providing an automated reconfiguration system for analyzing system reconfiguration for automated isolation of disturbances to a power distribution system;

(b) detecting a triggering event, wherein the triggering event may indicate a disturbance within the power distribution system;

(c) scanning at least a first circuit of the power distribution system to update a predetermined set of data relating to a plurality of controlled devices located within the first circuit, wherein the first circuit may comprise at least a first circuit path;

(d) autonomously updating at least a first table, wherein the first table may comprise data associated with the first circuit path and the first table may comprise a plurality of sets of rows, wherein the plurality of sets of rows may be arranged to form a plurality of sets of columns, wherein each set of columns may comprise at least a first set of rows and a second set of rows,
wherein the first set of rows may comprise a plurality of device rows and each of the plurality of device rows may comprise data relating to one of the controlled devices located on the first circuit path of the first circuit and the plurality of device rows may be arranged in a sequential manner beginning with a normally open point and proceeding upstream to a source of supply, wherein a first binary indicator may be used to indicate the status of each of the controlled devices;
wherein the second set of rows comprises a single row comprising data indicating the status of the first circuit path and a second binary indicator may be used to indicate the status of the first circuit path;
wherein the plurality of sets of columns may comprise a first set of columns;

(e) determining a type of disturbance comprised by the disturbance, wherein the type of disturbance may be at least partially determined by analyzing the first table;

(f) determining a circuit segment comprising the disturbance wherein the circuit segment comprising the disturbance may be at least partially determined by analyzing the first table; scanning down the first set of columns;

(g) isolating the disturbance;

(h) determining a non-energized non-faulted portion of the circuit segment;

(i) identifying an alternate source of electric supply;

(j)terminating the method if the alternate source of electric supply is determined to be unavailable to energize the non-energized non-faulted portion of the circuit segment; and,

(k) reconfiguring the power distribution system if the alternate source of electric supply is determined to be available, wherein the power distribution system is reconfigured such that the non-energized non-faulted portion of the circuit segment is energized by the alternate source of electric supply.

According to one embodiment of the invention, a method for analyzing system reconfiguration for automated isolation of disturbances to a power distribution system may comprise the steps of:

(a) providing an automated reconfiguration system for analyzing system reconfiguration for automated isolation of disturbances to a power distribution system;

(b) detecting a triggering event, wherein the triggering event may indicate a disturbance within the power distribution system;

(c) scanning at least a first circuit of the power distribution system to update a predetermined set of data relating to a plurality of controlled devices located within the first circuit, wherein the first circuit may comprise at least a first circuit path;

(d) autonomously updating at least a first table, wherein the first table may comprise data associated with the first circuit path and the first table may comprise a plurality of sets of rows, wherein the plurality of sets of rows may be arranged to form a plurality of sets of columns, wherein each set of columns may comprise at least a first set of rows and a second set of rows,
wherein the first set of rows may comprise a plurality of device rows and each of the plurality of device rows may comprise data relating to one of the controlled devices located on the first circuit path of the first circuit and the plurality of device rows may be arranged in a sequential manner beginning with a normally open point and proceeding upstream to a source of supply, wherein a first binary indicator may be used to indicate the status of each of the controlled devices;
wherein the second set of rows may comprise a single row comprising data indicating the status of the first circuit path and a second binary indicator may be used to indicate the status of the first circuit path;
wherein the plurality of sets of columns may comprise a first set of columns;

(e) determining a type of disturbance comprised by the disturbance, wherein the type of disturbance may be at least partially determined by analyzing the first table;

(f) determining a circuit segment comprising the disturbance wherein the circuit segment comprising the disturbance may be at least partially determined by analyzing the first table;

scanning down the first set of columns;

identifying the location of the disturbance at a first change in the first binary indicator;

(g) isolating the disturbance;

(h) determining a non-energized non-faulted portion of the circuit segment;

(i) identifying an alternate source of electric supply;

(j) terminating the method if the alternate source of electric supply is determined to be unavailable to energize the non-energized non-faulted portion of the circuit segment; and,

(k) reconfiguring the power distribution system if the alternate source of electric supply is determined to be available, wherein the power distribution system is reconfigured such that the non-energized non-faulted portion of the circuit segment is energized by the alternate source of electric supply.

According to one embodiment of the invention, a method for analyzing system reconfiguration for automated isolation of disturbances to a power distribution system may comprise the steps of:

(a) providing an automated reconfiguration system for analyzing system reconfiguration for automated isolation of disturbances to a power distribution system;

(b) detecting a triggering event, wherein the triggering event may indicate a disturbance within the power distribution system;

(c) scanning at least a first circuit of the power distribution system to update a predetermined set of data relating to a plurality of controlled devices located within the first circuit, wherein the first circuit may comprise at least a first circuit path;

(d) autonomously updating at least a first table, wherein the first table may comprise data associated with the first circuit path and the first table may comprise a plurality of sets of rows, wherein the plurality of sets of rows may be arranged to form a plurality of sets of columns, wherein each set of columns may comprise at least a first set of rows and a second set of rows, wherein the first set of rows may comprise a plurality of device rows and each of the plurality of device rows may comprise data relating to one of the controlled devices located on the first circuit path of the first circuit and the plurality of device rows may be arranged in a sequential manner beginning with a normally open point and proceeding upstream to a source of supply, wherein a first binary indicator may be used to indicate the status of each of the controlled devices;

wherein the second set of rows may comprise a single row comprising data indicating the status of the first circuit path and a second binary indicator may be used to indicate the status of the first circuit path;

(e) determining a type of disturbance comprised by the disturbance, wherein the type of disturbance may be at least partially determined by analyzing the first table;

determining the disturbance to comprise a fault disturbance;

(f) determining a circuit segment comprising the disturbance wherein the circuit segment comprising the disturbance may be at least partially determined by analyzing the first table;

(g) isolating the disturbance;

opening the controlled devices located on either side of the fault disturbance;

(h) determining a non-energized non-faulted portion of the circuit segment;

(i) identifying an alternate source of electric supply;

(j) terminating the method if the alternate source of electric supply is determined to be unavailable to energize the non-energized non-faulted portion of the circuit segment; and,

(k) reconfiguring the power distribution system if the alternate source of electric supply is determined to be available, wherein the power distribution system is reconfigured such that the non-energized non-faulted portion of the circuit segment is energized by the alternate source of electric supply.

According to one embodiment of the invention, a method for analyzing system reconfiguration for automated isolation of disturbances to a power distribution system may comprise the steps of:

(a) providing an automated reconfiguration system for analyzing system reconfiguration for automated isolation of disturbances to a power distribution system;

wherein the automated reconfiguration system may comprise a display device;

displaying the first table, wherein the display device at least partially allows an operator to perform maintenance and trouble-shooting operations;

(b) detecting a triggering event, wherein the triggering event may indicate a disturbance within the power distribution system;

(c) scanning at least a first circuit of the power distribution system to update a predetermined set of data relating to a plurality of controlled devices located within the first circuit, wherein the first circuit may comprise at least a first circuit path;

(d) autonomously updating at least a first table, wherein the first table may comprise data associated with the first circuit path and the first table may comprise a plurality of sets of rows, wherein the plurality of sets of rows may be arranged to form a plurality of sets of columns, wherein each set of columns may comprise at least a first set of rows and a second set of rows,
wherein the first set of rows may comprise a plurality of device rows and each of the plurality of device rows may comprise data relating to one of the controlled devices located on the first circuit path of the first circuit and the plurality of device rows may be arranged in a sequential manner beginning with a normally open point and proceeding upstream to a source of supply, wherein a first binary indicator may be used to indicate the status of each of the controlled devices;
wherein the second set of rows may comprise a single row comprising data indicating the status of the first circuit path and a second binary indicator may be used to indicate the status of the first circuit path;

(e) determining a type of disturbance comprised by the disturbance, wherein the type of disturbance may be at least partially determined by analyzing the first table;

(f) determining a circuit segment comprising the disturbance wherein the circuit segment comprising the disturbance may be at least partially determined by analyzing the first table;

(g) isolating the disturbance;

(h) determining a non-energized non-faulted portion of the circuit segment;

(i) identifying an alternate source of electric supply;

(j) terminating the method if the alternate source of electric supply is determined to be unavailable to energize the non-energized non-faulted portion of the circuit segment; and,

(k) reconfiguring the power distribution system if the alternate source of electric supply is determined to be available, wherein the power distribution system is reconfigured such that the non-energized non-faulted portion of the circuit segment is energized by the alternate source of electric supply.

According to one embodiment of the invention, a method for analyzing system reconfiguration for automated isolation of disturbances to a power distribution system may comprise the steps of:

(a) providing an automated reconfiguration system for analyzing system reconfiguration for automated isolation of disturbances to a power distribution system, wherein the automated reconfiguration system may comprise a computing platform;

implementing the method for isolating the disturbances to the power distribution system at least partially utilizing the computing platform;

(b) detecting a triggering event, wherein the triggering event may indicate a disturbance within the power distribution system;

(c) scanning at least a first circuit of the power distribution system to update a predetermined set of data relating to a plurality of controlled devices located within the first circuit, wherein the first circuit may comprise at least a first circuit path;

(d) autonomously updating at least a first table, wherein the first table may comprise data associated with the first circuit path and the first table may comprise a plurality of sets of rows, wherein the plurality of sets of rows may be arranged to form a plurality of sets of columns, wherein each set of columns may comprise at least a first set of rows and a second set of rows,
wherein the first set of rows may comprise a plurality of device rows and each of the plurality of device rows may comprise data relating to one of the controlled devices located on the first circuit path of the first circuit and the plurality of device rows may be arranged in a sequential manner beginning with a normally open point and proceeding upstream to a source of supply, wherein a first binary indicator may be used to indicate the status of each of the controlled devices;
wherein the second set of rows may comprise a single row comprising data indicating the status of the first circuit path and a second binary indicator may be used to indicate the status of the first circuit path;

(e) determining a type of disturbance comprised by the disturbance, wherein the type of disturbance may be at least partially determined by analyzing the first table;

(f) determining a circuit segment comprising the disturbance wherein the circuit segment comprising the disturbance may be at least partially determined by analyzing the first table;

(g) isolating the disturbance;

(h) determining a non-energized non-faulted portion of the circuit segment;

(i) identifying an alternate source of electric supply;

(j) terminating the method if the alternate source of electric supply is determined to be unavailable to energize the non-energized non-faulted portion of the circuit segment; and,

(k) reconfiguring the power distribution system if the alternate source of electric supply is determined to be available, wherein the power distribution system is reconfigured such that the non-energized non-faulted portion of the circuit segment is energized by the alternate source of electric supply.

According to one embodiment of the invention, a first computing platform for implementing a method for analyzing system reconfiguration for automated isolation of disturbances to a power distribution system, wherein the first computing platform implements the method in response to the execution of a computer-executable instruction, wherein the method may comprise the steps of:

(a) providing an automated reconfiguration system for analyzing system reconfiguration for automated isolation of disturbances to a power distribution system;

(b) detecting a triggering event, wherein the triggering event may indicate a disturbance within the power distribution system;

(c) scanning at least a first circuit of the power distribution system to update a predetermined set of data relating to a plurality of controlled devices located within the first circuit, wherein the first circuit may comprise at least a first circuit path;

(d) autonomously updating at least a first table, wherein the first table may comprise data associated with the first circuit path and the first table may comprise a plurality of sets of rows, wherein the plurality of sets of rows may be arranged to form a plurality of sets of columns, wherein each set of columns may comprise at least a first set of rows and a second set of rows,
wherein the first set of rows may comprise a plurality of device rows and each of the plurality of device rows may comprise data relating to one of the controlled devices located on the first circuit path of the first circuit and the plurality of device rows may be arranged in a sequential manner beginning with a normally open point and proceeding upstream to a source of supply, wherein a first binary indicator may be used to indicate the status of each of the controlled devices;
wherein the second set of rows may comprise a single row comprising data indicating the status of the first circuit path and a second binary indicator may be used to indicate the status of the first circuit path;

(e) determining a type of disturbance comprised by the disturbance, wherein the type of disturbance may be at least partially determined by analyzing the first table;

(f) determining a circuit segment comprising the disturbance wherein the circuit segment comprising the disturbance may be at least partially determined by analyzing the first table;

(g) isolating the disturbance;

(h) determining a non-energized non-faulted portion of the circuit segment;

(i) identifying an alternate source of electric supply;

(j) terminating the method if the alternate source of electric supply is determined to be unavailable to energize the non-energized non-faulted portion of the circuit segment; and,

(k) reconfiguring the power distribution system if the alternate source of electric supply is determined to be available, wherein the power distribution system is reconfigured such that the non-energized non-faulted portion of the circuit segment is energized by the alternate source of electric supply.

According to one embodiment of the invention, a first computing platform for implementing a method for analyzing system reconfiguration for automated isolation of disturbances to a power distribution system, wherein the first computing platform may implement the method in response to the execution of a computer- executable instruction, wherein the first computing platform may operate in a networked environment using a logical connection to a second computing platform, wherein the method may comprise the steps of:

(a) providing an automated reconfiguration system for analyzing system reconfiguration for automated isolation of disturbances to a power distribution system;

(b) detecting a triggering event, wherein the triggering event may indicate a disturbance within the power distribution system;

(c) scanning at least a first circuit of the power distribution system to update a predetermined set of data relating to a plurality of controlled devices located within the first circuit, wherein the first circuit may comprise at least a first circuit path;

(d) autonomously updating at least a first table, wherein the first table may comprise data associated with the first circuit path and the first table may comprise a plurality of sets of rows, wherein the plurality of sets of rows may be arranged to form a plurality of sets of columns, wherein each set of columns may comprise at least a first set of rows and a second set of rows,
wherein the first set of rows may comprise a plurality of device rows and each of the plurality of device rows may comprise data relating to one of the controlled devices located on the first circuit path of the first circuit and the plurality of device rows may be arranged in a sequential manner beginning with a normally open point and proceeding upstream to a source of supply, wherein a first binary indicator may be used to indicate the status of each of the controlled devices;
wherein the second set of rows may comprise a single row comprising data indicating the status of the first circuit path and a second binary indicator may be used to indicate the status of the first circuit path;

(e) determining a type of disturbance comprised by the disturbance, wherein the type of disturbance may be at least partially determined by analyzing the first table;

(f) determining a circuit segment comprising the disturbance wherein the circuit segment comprising the disturbance may be at least partially determined by analyzing the first table;

(g) isolating the disturbance;

(h) determining a non-energized non-faulted portion of the circuit segment;

(i) identifying an alternate source of electric supply;

(j) terminating the method if the alternate source of electric supply is determined to be unavailable to energize the non-energized non-faulted portion of the circuit segment; and,

(k) reconfiguring the power distribution system if the alternate source of electric supply is determined to be available, wherein the power distribution system is reconfigured such that the non-energized non-faulted portion of the circuit segment is energized by the alternate source of electric supply.

According to one embodiment of the invention, a first computing platform for implementing a method for analyzing system reconfiguration for automated isolation of disturbances to a power distribution system, wherein the first computing platform may implement the method in response to the execution of a computer-executable instruction, wherein the first computing platform may operate in a networked environment using a logical connection to a second computing platform, wherein the logical connection may comprise a local area network, wherein the method may comprise the steps of:

(a) providing an automated reconfiguration system for analyzing system reconfiguration for automated isolation of disturbances to a power distribution system;

(b) detecting a triggering event, wherein the triggering event may indicate a disturbance within the power distribution system;

(c) scanning at least a first circuit of the power distribution system to update a predetermined set of data relating to a plurality of controlled devices located within the first circuit, wherein the first circuit may comprise at least a first circuit path;

(d) autonomously updating at least a first table, wherein the first table may comprise data associated with the first circuit path and the first table may comprise a plurality of sets of rows, wherein the plurality of sets of rows may be arranged to form a plurality of sets of columns, wherein each set of columns may comprise at least a first set of rows and a second set of rows,
wherein the first set of rows may comprise a plurality of device rows and each of the plurality of device rows may comprise data relating to one of the controlled devices located on the first circuit path of the first circuit and the plurality of device rows may be arranged in a sequential manner beginning with a normally open point and proceeding upstream to a source of supply, wherein a first binary indicator may be used to indicate the status of each of the controlled devices;
wherein the second set of rows may comprise a single row comprising data indicating the status of the first circuit path and a second binary indicator may be used to indicate the status of the first circuit path;

(e) determining a type of disturbance comprised by the disturbance, wherein the type of disturbance may be at least partially determined by analyzing the first table;

(f) determining a circuit segment comprising the disturbance wherein the circuit segment comprising the disturbance may be at least partially determined by analyzing the first table;

(g) isolating the disturbance;

(h) determining a non-energized non-faulted portion of the circuit segment;

(i) identifying an alternate source of electric supply;

(j) terminating the method if the alternate source of electric supply is determined to be unavailable to energize the non-energized non-faulted portion of the circuit segment; and,

(k) reconfiguring the power distribution system if the alternate source of electric supply is determined to be available, wherein the power distribution system is reconfigured such that the non-energized non-faulted portion of the circuit segment is energized by the alternate source of electric supply.

According to one embodiment of the invention, a first computing platform for implementing a method for analyzing system reconfiguration for automated isolation for disturbances to a power distribution system, wherein the first computing platform may implement the method in response to the execution of a computer-executable instruction, wherein the first computing platform may operate in a networked environment using a logical connection to a second computing platform, wherein the logical connection may comprise a wide area network, wherein the method may comprise the steps of:

(a) providing an automated reconfiguration system for analyzing system reconfiguration for automated isolation of disturbances to a power distribution system;

(b) detecting a triggering event, wherein the triggering event may indicate a disturbance within the power distribution system;

(c) scanning at least a first circuit of the power distribution system to update a predetermined set of data relating to a plurality of controlled devices located within the first circuit, wherein the first circuit may comprise at least a first circuit path;

(d) autonomously updating at least a first table, wherein the first table may comprise data associated with the first circuit path and the first table may comprise a plurality of sets of rows, wherein the plurality of sets of rows may be arranged to form a plurality of sets of columns, wherein each set of columns may comprise at least a first set of rows and a second set of rows,
wherein the first set of rows may comprise a plurality of device rows and each of the plurality of device rows may comprise data relating to one of the controlled devices located on the first circuit path of the first circuit and the plurality of device rows may be arranged in a sequential manner beginning with a normally open point and proceeding upstream to a source of supply, wherein a first binary indicator may be used to indicate the status of each of the controlled devices;
wherein the second set of rows may comprise a single row comprising data indicating the status of the first circuit path and a second binary indicator may be used to indicate the status of the first circuit path;

(e) determining a type of disturbance comprised by the disturbance, wherein the type of disturbance may be at least partially determined by analyzing the first table;

(f) determining a circuit segment comprising the disturbance wherein the circuit segment comprising the disturbance may be at least partially determined by analyzing the first table;

(g) isolating the disturbance;

(h) determining a non-energized non-faulted portion of the circuit segment;

(i) identifying an alternate source of electric supply;

(j) terminating the method if the alternate source of electric supply is determined to be unavailable to energize the non-energized non-faulted portion of the circuit segment; and,

(k) reconfiguring the power distribution system if the alternate source of electric supply is determined to be available, wherein the power distribution system is reconfigured such that the non-energized non-faulted portion of the circuit segment is energized by the alternate source of electric supply.

According to one embodiment of the invention, a first computing platform for implementing a method for analyzing system reconfiguration for automated isolation of disturbances to a power distribution system, wherein the first computing platform may implement the method in response to the execution of a computer-executable instruction, wherein the first computing platform may operate in a networked environment using a logical connection to a second computing platform, wherein the logical connection may comprise an internet, wherein the method may comprise the steps of:

(a) providing an automated reconfiguration system for analyzing system reconfiguration for automated isolation of disturbances to a power distribution system;

(b) detecting a triggering event, wherein the triggering event may indicate a disturbance within the power distribution system;

(c) scanning at least a first circuit of the power distribution system to update a predetermined set of data relating to a plurality of controlled devices located within the first circuit, wherein the first circuit may comprise at least a first circuit path;

(d) autonomously updating at least a first table, wherein the first table may comprise data associated with the first circuit path and the first table may comprise a plurality of sets of rows, wherein the plurality of sets of rows may be arranged to form a plurality of sets of columns, wherein each set of columns may comprise at least a first set of rows and a second set of rows,
wherein the first set of rows may comprise a plurality of device rows and each of the plurality of device rows may comprise data relating to one of the controlled devices located on the first circuit path of the first circuit and the plurality of device rows may be arranged in a sequential manner beginning with a normally open point and proceeding upstream to a source of supply, wherein a first binary indicator may be used to indicate the status of each of the controlled devices;
wherein the second set of rows may comprise a single row comprising data indicating the status of the first circuit path and a second binary indicator may be used to indicate the status of the first circuit path;

(e) determining a type of disturbance comprised by the disturbance, wherein the type of disturbance may be at least partially determined by analyzing the first table;

(f) determining a circuit segment comprising the disturbance wherein the circuit segment comprising the disturbance may be at least partially determined by analyzing the first table;

(g) isolating the disturbance;

(h) determining a non-energized non-faulted portion of the circuit segment;

(i) identifying an alternate source of electric supply;

(j) terminating the method if the alternate source of electric supply is determined to be unavailable to energize the non-energized non-faulted portion of the circuit segment; and,

(k) reconfiguring the power distribution system if the alternate source of electric supply is determined to be available, wherein the power distribution system is reconfigured such that the non-energized non-faulted portion of the circuit segment is energized by the alternate source of electric supply.

According to one embodiment of the invention, a first computing platform for implementing a method for analyzing system reconfiguration for automated isolation of disturbances to a power distribution system, wherein the first computing platform may implement the method in response to the execution of a computer-executable instruction, wherein the first computing platform may comprise a display device for displaying the first table, wherein the display device at least partially allows an operator to perform maintenance and trouble-shooting operations, wherein the method may comprise the steps of:

(a) providing an automated reconfiguration system for analyzing system reconfiguration for automated isolation of disturbances to a power distribution system;

(b) detecting a triggering event, wherein the triggering event may indicate a disturbance within the power distribution system;

(c) scanning at least a first circuit of the power distribution system to update a predetermined set of data relating to a plurality of controlled devices located within the first circuit, wherein the first circuit may comprise at least a first circuit path;

(d) autonomously updating at least a first table, wherein the first table may comprise data associated with the first circuit path and the first table may comprise a plurality of sets of rows, wherein the plurality of sets of rows may be arranged to form a plurality of sets of columns, wherein each set of columns may comprise at least a first set of rows and a second set of rows,
wherein the first set of rows may comprise a plurality of device rows and each of the plurality of device rows may comprise data relating to one of the controlled devices located on the first circuit path of the first circuit and the plurality of device rows may be arranged in a sequential manner beginning with a normally open point and proceeding upstream to a source of supply, wherein a first binary indicator may be used to indicate the status of each of the controlled devices;
wherein the second set of rows may comprise a single row comprising data indicating the status of the first circuit path and a second binary indicator may be used to indicate the status of the first circuit path;

(e) determining a type of disturbance comprised by the disturbance, wherein the type of disturbance may be at least partially determined by analyzing the first table;

(f) determining a circuit segment comprising the disturbance wherein the circuit segment comprising the disturbance may be at least partially determined by analyzing the first table;

(g) isolating the disturbance;

(h) determining a non-energized non-faulted portion of the circuit segment;

(i) identifying an alternate source of electric supply;

(j) terminating the method if the alternate source of electric supply is determined to be unavailable to energize the non-energized non-faulted portion of the circuit segment; and,

(k) reconfiguring the power distribution system if the alternate source of electric supply is determined to be available, wherein the power distribution system is reconfigured such that the non-energized non-faulted portion of the circuit segment is energized by the alternate source of electric supply.

According to one embodiment of the invention, a method for analyzing system reconfiguration for automated isolation of disturbances to a power distribution system may comprise the steps of:

(a) providing an automated reconfiguration system for analyzing system reconfiguration for automated isolation of disturbances to a power distribution system;

(b) detecting a triggering event, wherein the triggering event may indicate a disturbance within the power distribution system;

(c) scanning at least a first circuit of the power distribution system to update a predetermined set of data relating to a plurality of controlled devices located within the first circuit, wherein the first circuit may comprise at least a first circuit path;

(d) autonomously updating at least a first table, wherein the first table may comprise data associated with the first circuit path and the first table may comprise a plurality of sets of rows, wherein the plurality of sets of rows may be arranged to form a plurality of sets of columns, wherein each set of columns may comprise at least a first set of rows and a second set of rows,
wherein the first set of rows may comprise a plurality of device rows and each of the plurality of device rows may comprise data relating to one of the controlled devices located on the first circuit path of the first circuit and the plurality of device rows may be arranged in a sequential manner beginning with a normally open point and proceeding upstream to a source of supply, wherein a first binary indicator may be used to indicate the status of each of the controlled devices;
wherein the second set of rows may comprise a single row comprising data indicating the status of the first circuit path and a second binary indicator may be used to indicate the status of the first circuit path;

(e) determining a type of disturbance comprised by the disturbance, wherein the type of disturbance may be at least partially determined by analyzing the first table;

(f) determining a circuit segment comprising the disturbance wherein the circuit segment comprising the disturbance may be at least partially determined by analyzing the first table;

(g) isolating the disturbance;

(h) determining a non-energized non-faulted portion of the circuit segment;

(i) identifying an alternate source of electric supply;

(j) terminating the method if the alternate source of electric supply is determined to be unavailable to energize the non-energized non-faulted portion of the circuit segment;

analyzing a second table to determine a second circuit path and an associated third table;

analyzing the third table to determine if the alternate source of electric supply is available; and,

(k) reconfiguring the power distribution system if the alternate source of electric supply is determined to be available, wherein the power distribution system is reconfigured such that the non-energized non-faulted portion of the circuit segment is energized by the alternate source of electric supply.

According to one embodiment of the invention, a computer-readable storage medium having computer-executable instructions to perform a method for analyzing system reconfiguration for automated isolation of disturbances to a power distribution system, wherein the method may comprise the steps of:

(a) detecting a triggering event, wherein the triggering event may indicate a disturbance within the power distribution system;

(b) scanning at least a first circuit of the power distribution system to update a predetermined set of data relating to a plurality of controlled devices located within the first circuit, wherein the first circuit may comprise at least a first circuit path;

(c) autonomously updating at least a first table, wherein the first table may comprise data associated with the first circuit path and the first table may comprise a plurality of sets of rows, wherein the plurality of sets of rows may be arranged to form a plurality of sets of columns, wherein each set of columns may comprise at least a first set of rows and a second set of rows,
wherein the first set of rows may comprise a plurality of device rows and each of the plurality of device rows may comprise data relating to one of the controlled devices located on the first circuit path of the first circuit and the plurality of device rows may be arranged in a sequential manner beginning with a normally open point and proceeding upstream to a source of supply, wherein a first binary indicator may be used to indicate the status of each of the controlled devices;
wherein the second set of rows may comprise a single row comprising data indicating the status of the first circuit path and a second binary indicator may be used to indicate the status of the first circuit path;

(d) determining a type of disturbance comprised by the disturbance, wherein the type of disturbance may be at least partially determined by analyzing the first table;

(e) determining a circuit segment comprising the disturbance wherein the circuit segment comprising the disturbance may be at least partially determined by analyzing the first table;

(f) isolating the disturbance;

(g) determining a non-energized non-faulted portion of the circuit segment;

(h) identifying an alternate source of electric supply;

(i) terminating the method if the alternate source of electric supply is determined to be unavailable to energize the non-energized non-faulted portion of the circuit segment; and,

(j) reconfiguring the power distribution system if the alternate source of electric supply is determined to be available, wherein the power distribution system is reconfigured such that the non-energized non-faulted portion of the circuit segment is energized by the alternate source of electric supply.

According to one embodiment of the invention, a computer-readable storage medium having computer-executable instructions to perform a method for analyzing system reconfiguration for automated isolation of disturbances to a power distribution system, wherein the method may comprise the steps of:

(a) detecting a triggering event, wherein the triggering event may indicate a disturbance within the power distribution system;

(b) scanning at least a first circuit of the power distribution system to update a predetermined set of data relating to a plurality of controlled devices located within the first circuit, wherein the first circuit may comprise at least a first circuit path;

(c) autonomously updating at least a first table, wherein the first table may comprise data associated with the first circuit path and the first table may comprise a plurality of sets of rows, wherein the plurality of sets of rows may be arranged to form a plurality of sets of columns, wherein each set of columns may comprise at least a first set of rows and a second set of rows,
wherein the first set of rows may comprise a plurality of device rows and each of the plurality of device rows may comprise data relating to one of the controlled devices located on the first circuit path of the first circuit and the plurality of device rows may be arranged in a sequential manner beginning with a normally open point and proceeding upstream to a source of supply, wherein a first binary indicator may be used to indicate the status of each of the controlled devices;
wherein the second set of rows may comprise a single row comprising data indicating the status of the first circuit path and a second binary indicator may be used to indicate the status of the first circuit path;
wherein the first table may comprise a first set of columns comprising a first column, a second column, and a third column, wherein the first column can be analyzed to indicate the type of disturbance as a fault disturbance, the second column can be analyzed to indicate the type of disturbance as a loss-of-voltage, and the third column can be analyzed to indicate the type of disturbance as an overload condition;

(d) determining a type of disturbance comprised by the disturbance, wherein the type of disturbance may be at least partially determined by analyzing the first table;

(e) determining a circuit segment comprising the disturbance wherein the circuit segment comprising the disturbance may be at least partially determined by analyzing the first table;

(f) isolating the disturbance;

(g) determining a non-energized non-faulted portion of the circuit segment;

(h) identifying an alternate source of electric supply;

(i) terminating the method if the alternate source of electric supply is determined to be unavailable to energize the non-energized non-faulted portion of the circuit segment; and,

(j) reconfiguring the power distribution system if the alternate source of electric supply is determined to be available, wherein the power distribution system is reconfigured such that the non-energized non-faulted portion of the circuit segment is energized by the alternate source of electric supply.

According to one embodiment of the invention, a computer-readable storage medium having computer-executable instructions to perform a method for automated isolation of disturbances to a power distribution system, wherein the method may comprise the steps of:

(a) detecting a triggering event, wherein the triggering event may indicate a disturbance within the power distribution system;

(b) scanning at least a first circuit of the power distribution system to update a predetermined set of data relating to a plurality of controlled devices located within the first circuit, wherein the first circuit may comprise at least a first circuit path;

(c) autonomously updating at least a first table, wherein the first table may comprise data associated with the first circuit path and the first table may comprise a plurality of sets of rows, wherein the plurality of sets of rows may be arranged to form a plurality of sets of columns, wherein each set of columns may comprise at least a first set of rows and a second set of rows,
wherein the first set of rows may comprise a plurality of device rows and each of the plurality of device rows may comprise data relating to one of the controlled devices located on the first circuit path of the first circuit and the plurality of device rows may be arranged in a sequential manner beginning with a normally open point and proceeding upstream to a source of supply, wherein a first binary indicator may be used to indicate the status of each of the controlled devices;
wherein the second set of rows may comprise a single row comprising data indicating the status of the first circuit path and a second binary indicator may be used to indicate the status of the first circuit path;
wherein the plurality of sets of columns of the first table may comprise a first set of columns and a second set of columns, wherein the first set of columns may comprise a first column, a second column, and a third column, wherein the first column can be analyzed to indicate the type of disturbance as a fault disturbance, the second column can be analyzed to indicate the type of disturbance as a loss-of-voltage, and the third column can be analyzed to indicate the type of disturbance as an overload condition; and,
wherein the second set of columns may comprise at least a first column that may comprise a first binary indicator indicating whether each of the plurality of controlled devices comprise a nominal position, wherein the nominal position of the normally open point may be open and the nominal position of the remaining devices comprising the plurality of controlled devices may be closed;

(d) determining a type of disturbance comprised by the disturbance, wherein the type of disturbance may be at least partially determined by analyzing the first table;

(e) determining a circuit segment comprising the disturbance wherein the circuit segment comprising the disturbance may be at least partially determined by analyzing the first table;

(f) isolating the disturbance;

(g) determining a non-energized non-faulted portion of the circuit segment;

(h) identifying an alternate source of electric supply;

(i) terminating the method if the alternate source of electric supply is determined to be unavailable to energize the non-energized non-faulted portion of the circuit segment; and,

(j) reconfiguring the power distribution system if the alternate source of electric supply is determined to be available, wherein the power distribution system is reconfigured such that the non-energized non-faulted portion of the circuit segment is energized by the alternate source of electric supply.

According to one embodiment of the invention, a computer-readable storage medium having computer-executable instructions to perform a method for analyzing system reconfiguration for automated isolation of disturbances to a power distribution system, wherein the method may comprise the steps of:

(a) detecting a triggering event, wherein the triggering event may indicate a disturbance within the power distribution system;

(b) scanning at least a first circuit of the power distribution system to update a predetermined set of data relating to a plurality of controlled devices located within the first circuit, wherein the first circuit may comprise at least a first circuit path;

(c) autonomously updating at least a first table, wherein the first table may comprise data associated with the first circuit path and the first table may comprise a plurality of sets of rows, wherein the plurality of sets of rows may be arranged to form a plurality of sets of columns, wherein each set of columns may comprise at least a first set of rows and a second set of rows,
wherein the first set of rows may comprise a plurality of device rows and each of the plurality of device rows may comprise data relating to one of the controlled devices located on the first circuit path of the first circuit and the plurality of device rows may be arranged in a sequential manner beginning with a normally open point and proceeding upstream to a source of supply, wherein a first binary indicator may be used to indicate the status of each of the controlled devices;
wherein the second set of rows may comprise a single row comprising data indicating the status of the first circuit path and a second binary indicator may be used to indicate the status of the first circuit path;

(d) determining a type of disturbance comprised by the disturbance, wherein the type of disturbance may be at least partially determined by analyzing the first table;

determining the type of disturbance to comprise a fault disturbance;

(e) determining a circuit segment comprising the disturbance wherein the circuit segment comprising the disturbance may be at least partially determined by analyzing the first table;

(f) isolating the disturbance;
opening the controlled devices located on either side of the fault disturbance;

(g) determining a non-energized non-faulted portion of the circuit segment;

(h) identifying an alternate source of electric supply;

(i) terminating the method if the alternate source of electric supply is determined to be unavailable to energize the non-energized non-faulted portion of the circuit segment; and,

(j) reconfiguring the power distribution system if the alternate source of electric supply is determined to be available, wherein the power distribution system is reconfigured such that the non-energized non-faulted portion of the circuit segment is energized by the alternate source of electric supply.

One advantage of this invention is that rather than programming each disturbance scenario individually this methodology provides a quick and systematic process to reconfigure a set of circuits equipped with the ability to change their topology in response to system disturbances. This methodology considers the type of disturbance, where the disturbance occurred, and available topologies. Among available topologies the methodology includes safety and capacity considerations.

Still other benefits and advantages of the invention will become apparent to those skilled in the art to which it pertains upon a reading and understanding of the following detailed specification.

### III. BRIEF DESCRIPTION OF THE DRAWINGS

The invention may take physical form in certain parts and arrangement of parts, a preferred embodiment of which will be described in detail in this specification and illustrated in the accompanying drawings which form a part hereof and wherein:

FIG. 1 shows a perspective diagramic view of the basic components of an electric power grid according to an embodiment of the present invention;

FIG. 2 shows a schematic illustration of a plurality of distribution system protection zones on a radial distribution circuit according to an embodiment of the present invention;

FIG. 3A shows a schematic illustration of a distribution automation topology diagram of a distribution system in its nominal state according to an embodiment of the present invention;

FIG. 3B shows a block diagram of an automated reconfiguration system according to one embodiment of the invention;

FIG. 3C shows a table associated with a particular circuit path according to one embodiment of the invention;

FIG. 4A shows a portion of the tables associated with the circuit paths comprising the distribution system shown in FIG. 3A according to one embodiment of the invention;

FIG. 4B shows an additional portion of tables associated with the circuit paths of the distribution system shown in FIG. 3A;

FIG. 4C shows an additional portion of tables associated with the circuit paths of the distribution system shown in FIG. 3A;

FIG. 5 shows a schematic illustration of the automation topology diagram shown in FIG. 3A further depicting a fault disturbance;

FIG. 6A shows a portion of the tables associated with the circuit paths comprising the distribution system shown in FIG. 5 according to one embodiment of the invention;

FIG. 6B shows an additional portion of tables associated with the circuit paths of the distribution system shown in FIG. 5;

FIG. 6C shows an additional portion of tables associated with the circuit paths of the distribution system shown in FIG. 5;

FIG. 7 shows a table of circuit paths and associated alternate sources in accordance with one embodiment of the invention.

### IV. DETAILED DESCRIPTION OF THE INVENTION

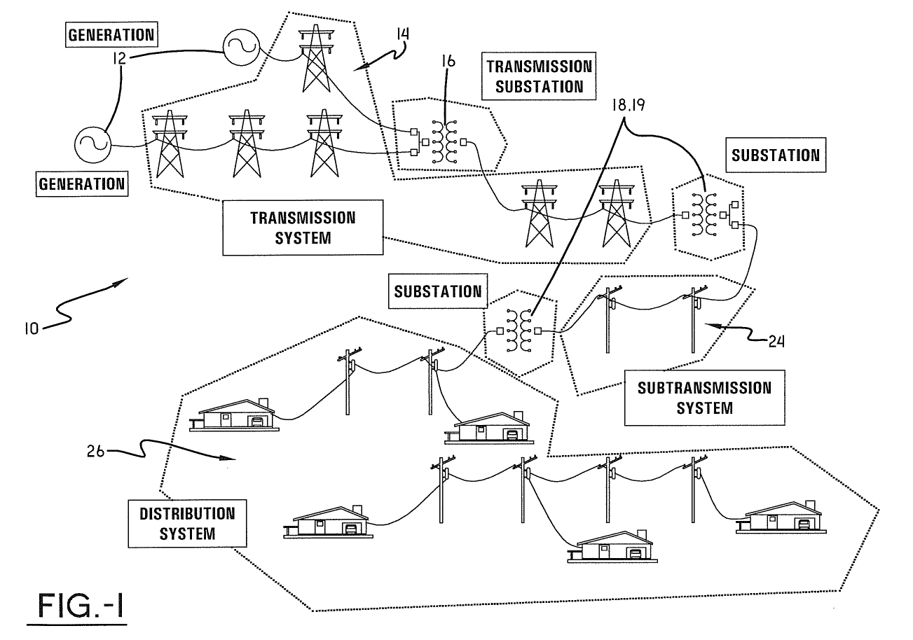

Referring now to the drawings wherein the showings are for purposes of illustrating embodiments of the invention only and not for purposes of limiting the same, FIG. 1 shows an electric power grid 10 comprising a primary source of electric supply 12, a transmission system 14, a transmission substation 16, a substation 18, a sub-transmission system 24 and a first distribution system 26. The first distribution system 26 comprises the portion of the electric power grid 10 that transports electricity from the higher voltage transmission system 14 or the sub-transmission system 24 and delivers it to an electricity consumer or end user 22. The substation 18 comprises a delineation point 19 between the first distribution system 26 and the transmission system 14 or the sub-transmission system 24.

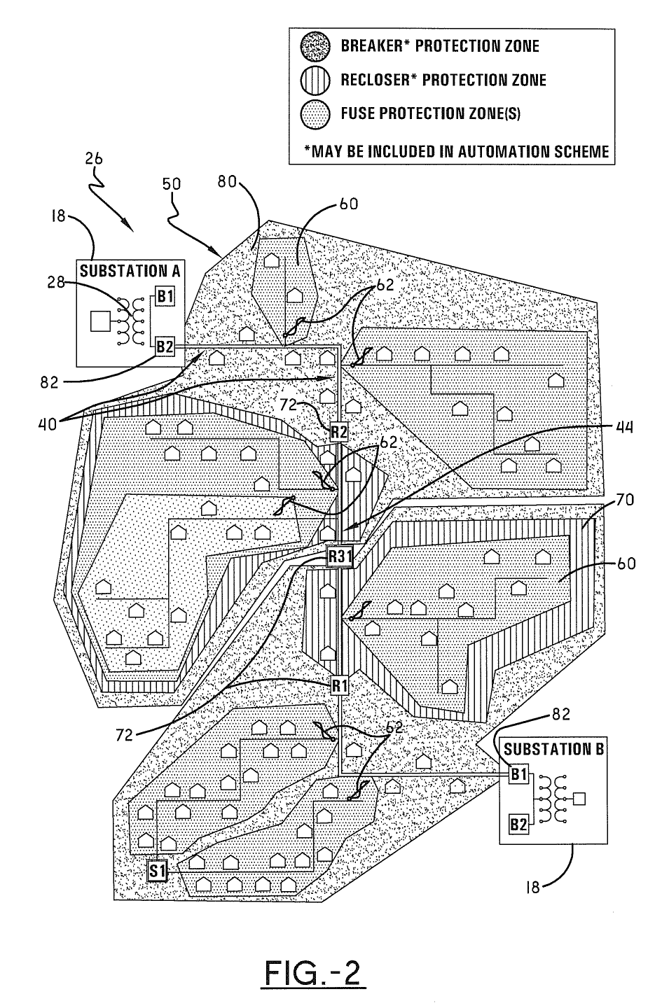

With reference now to FIG. 2, the first distribution system 26 may comprise a multi-circuit radial distribution system. The first distribution system 26 may comprise a plurality of distribution system circuits 40 wherein each of the plurality of distribution system circuits 40 is operated with a single source of electric supply. In one embodiment, the substation 18 comprises the single source of electric supply for one of the plurality of distribution system circuits 40.

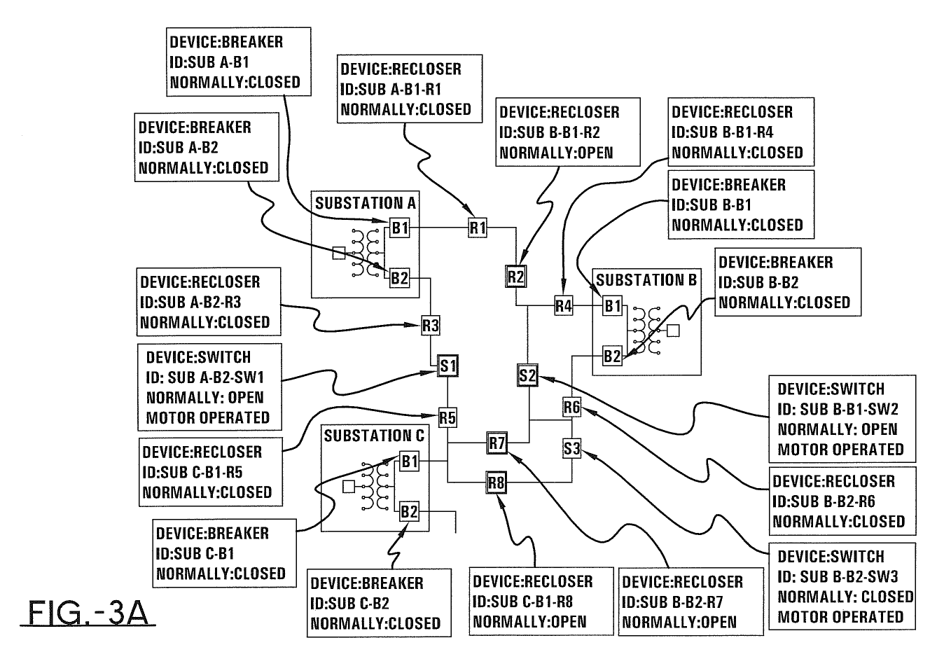

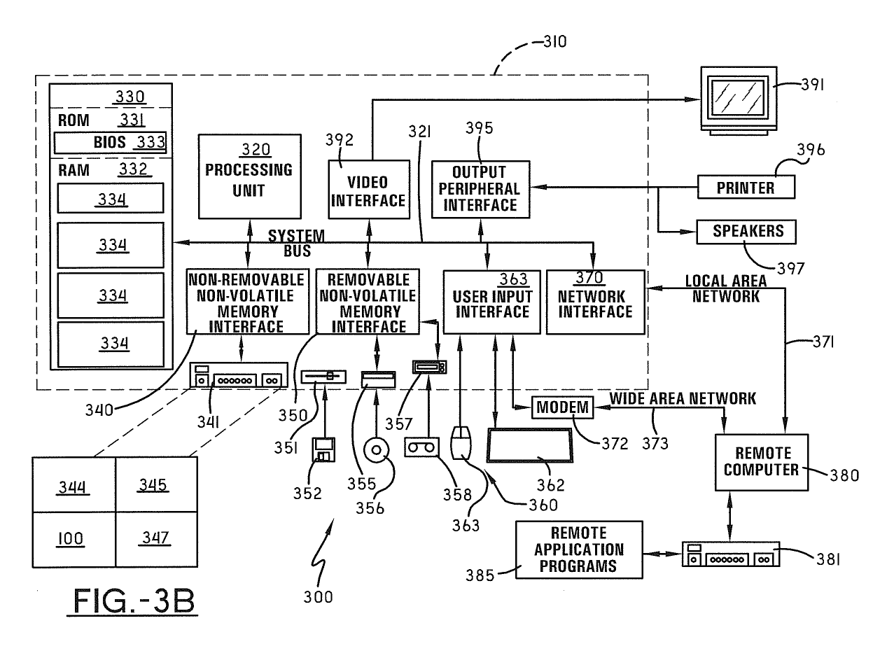

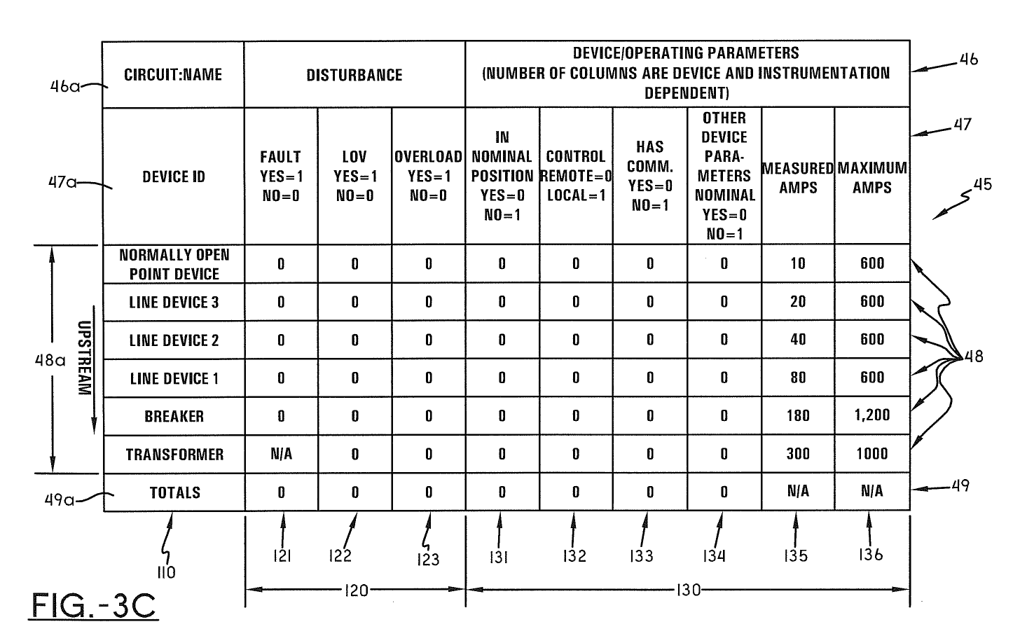

With continued reference now to FIG. 2, in one embodiment, first distribution system 26 may comprise a protection scheme 50 and an automated reconfiguration system 100 (as shown in FIG. 3B). The protection scheme 50 may comprise a zoned or tiered structure of protective circuit-interrupting devices 62, 72, and 82. FIG. 2 shows the relative position of the protective circuit-interrupting devices 62, 72, and 82 on the distribution system circuits 40. The protective circuit-interrupting devices 62, 72, and 82 may comprise multi-operation devices that can be remotely controlled to open and close such as breakers, reclosers, sectionalizers, and motor operated switches as well as single operation devices, such as fuses, that operate to destruction. In one embodiment, the protection scheme 50 may provide the first distribution system 26 with a first layer of protection 60, a second layer of protection 70, and a third layer of protection 80. The first layer of protection 60 may comprise at least a first circuit-interrupting device 62 that may be located on a circuit lateral tap where, due to topology, alternate sources of electric supply are not available. The first circuit-interrupting device 62 may be tiered relative to another first circuit-interrupting device 62. In one embodiment of the invention, the first circuit-interrupting device 62 may comprise a fuse.

With continued reference to FIG. 2, the second layer of protection 70 may comprise at least a second circuit-interrupting device 72. The second circuit-interrupting device 72 may be positioned in the main trunk 44 of one of the plurality of circuits 40 comprising the first distribution system 26. The second circuit-interrupting device 72 may protect the upstream portion of the first distribution system 26 from disturbances occurring downstream that are not first isolated by the first circuit-interrupting device 62. In one embodiment, the second circuit-interrupting device 72 may comprise a recloser. The third layer of protection 80 may comprise at least a third circuit-interrupting device 82 that may be placed at the substation 18 between the substation transformer 28 and at least one circuit of the plurality of circuits 40. The third circuit-interrupting device may protect the substation 18 and the upstream transmission system 14 from disturbances occurring on the first distribution system 26 that are not first isolated by either the first circuit-interrupting device 62 or the second circuit-interrupting device 72. In one embodiment, the third circuit-interrupting device 82 may comprise a breaker. The protective circuit-interrupting devices 62, 72, and 82 may comprise any type of device chosen with sound judgment by a person of ordinary skill in the art.

With reference now to FIGS. 1, 2, and 3B, the automated reconfiguration system 100 may minimize the prolonged impact of a disturbance within the first distribution system 26. The automated reconfiguration system 100 may minimize the prolonged impact of a disturbance by autonomously switching or reconfiguring entire circuits or circuit segments of the plurality of circuits 40 comprising the first distribution system 26 from one source of electric supply to another source of electric supply. In one embodiment, the automated reconfiguration system 100 may switch or reconfigure an entire circuit or circuit segment of the first distribution system 26 to restore service to a portion of the first distribution system 26 following a disturbance such as a fault, a loss-of-voltage event, or an overload condition. A fault may comprise an over-current condition where the current flowing through the first distribution system 26 exceeds a threshold level. A loss-of-voltage event may comprise a condition created by a loss of electric supply in either the transmission system 14 or the substation 18. Additionally, a loss-of-voltage event may comprise a condition wherein the first distribution system 26 comprises an undesired open condition that is undetected by the protection scheme 50. An overload condition may comprise a condition wherein the protective scheme 50 operates to prevent the overloading of substation equipment or the mainline conductor.

With reference now to FIG. 3B, an example of a suitable computing platform environment 300 for implementing the automated reconfiguration system 100 according to one embodiment is illustrated. The computing platform environment 300 is only one example of a suitable computing platform environment and is not intended to suggest any limitation as to the scope of use or functionality of the automated reconfiguration system 100. Neither should the computing platform environment 300 be interpreted as having any dependency or requirement relating to any one or combination of components illustrated in the exemplary operating computing platform environment 300. The automated reconfiguration system 100 is operational with numerous other general purpose or special purpose computing platform environments or configurations. Examples of well known computing platforms, environments, and/or configurations that may be suitable for use with the automated reconfiguration system 100 include, but are not limited to, personal computers, server computers, hand-held or laptop devices, multiprocessor systems, microprocessor-based systems, program logic controllers (PLC), remote terminal units (RTU), data concentrators, system control and data acquisition (SCADA) devices, programmable consumer electronics, network PCs, minicomputers, mainframe computers, distributed computing environments that include any of the above systems or devices, and the like. The automated reconfiguration system 100 may be described in the general context of computer-executable instructions, such as program modules, being executed by a computer. Generally, program modules include routines, programs, objects, components, data structures, etc. that perform particular tasks or implement particular abstract data types. The automated reconfiguration system 100 may also be practiced in distributed computing platform environments where tasks are performed by remote processing devices that are linked through a communications network or other data transmission medium. In a distributed computing platform environment, program modules and other data may be located in both local and remote computer storage media including memory storage devices.

With continued reference to FIG. 3B, according to one embodiment, a system for implementing the automated reconfiguration system 100 includes a general purpose computing system or platform in the form of a computing platform 310. The computing platform 310 may include a plurality of computer system components including, but not limited to, a processing unit 320, a memory portion 330, and a system bus 321. The system bus 321 may couple various system components including the memory portion 330 to the processing unit 320. The system bus 321 may be any of several types of bus structures including a memory bus or memory controller, a peripheral bus, and a local bus using any of a variety of bus architectures chosen with sound judgement by a person of ordinary skill.

With continued reference to FIG. 3B, the computing platform 310 may include a plurality of computer readable media. The computer readable media can be any available media that can be accessed by the computing platform 310 and includes both volatile and nonvolatile media, removable and non-removable media. By way of example, and not limitation, the computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can accessed by the computing platform 310. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The computing platform 310 may comprise any of the computer readable media or any combination of computer readable chosen with sound judgment by a person of ordinary skill in the art.

With continued reference to FIG. 3B, the memory portion 330 may include computer storage media in the form of volatile and/or nonvolatile memory such as read only memory (ROM) 331 and random access memory (RAM) 332. The computing platform 310 may comprise a basic input/output system 333 (BIOS). The BIOS 333 may contain the basic routines that at least partially enable the transfer of information between the plurality of system components within the computing platform 310. The BIOS 333 may be stored in the ROM 331. The RAM 332 may contain data and/or program modules 334 that are immediately accessible to and/or presently being operated on by the processing unit 320. Additionally, the computing platform 310 may also include other removable/non-removable, volatile/nonvolatile computer storage media. The computing platform 310 may comprise a hard disk drive 340, a magnetic disk drive 351, a nonvolatile magnetic disk drive 352, an optical disk drive 355, and/or a sequential media drive 357. The hard disk drive 340 may read from or write to a non-removable, nonvolatile magnetic media. The magnetic disk drive 351 may read from or write to a removable, nonvolatile magnetic disk 352. The optical disk drive 355 may read from or write to a removable, nonvolatile optical disk 356, such as a CD ROM or other optical media. The sequential media drive 357 may read from or write to a removable, nonvolatile sequential medium 358, such as a magnetic tape cassette or reel-to-reel tape. Other removable/non-removable, volatile/nonvolatile computer storage media that can be used may include, but are not limited to, flash memory cards, digital versatile disks, digital video tape, solid state RAM, solid state ROM, and any other type of computer storage media chosen with sound judgment by a person of ordinary skill in the art. The hard disk drive 341 may be connected to the system bus 321 through a non-removable memory interface such as interface 340. The magnetic disk drive 351 and the optical disk drive 355 may be connected to the system bus 321 by a removable memory interface, such as interface 350.

With continued reference to FIG. 3B, the drives and their associated computer storage media discussed above may provide storage of computer readable instructions, data structures, program modules and other data for the computing platform 310. In one embodiment, the hard disk drive 341 may be used to store an operating system 344, application programs 345, the automated reconfiguration system 100, as well as other data 347. The computing platform 310 may comprise a plurality of input devices 360 that allow a user to enter commands and information into the computing platform 310. The plurality of input devices 360 may include input devices such as a keyboard 362 and a pointing device 361 (commonly referred to as a mouse, trackball or touch pad) or any other input device chosen with sound judgment by a person of ordinary skill in the art. The plurality of input devices 360 may be connected to the processing unit 320 through a user input interface 363. The user input interface 363 may be coupled to the system bus 321. The computing platform 310 may comprise a plurality of output devices 390. The plurality of output devices 390 may include a display device 391, an audio speaker system 197, and a printer device 396. The display device 391 may be connected to the system bus 321 via a video interface 392. The audio speaker system 397 and the printer device 396 may be connected to the system bus 321 via an output peripheral interface 395.

With continued reference to FIG. 3B, the computing platform 310 may operate in a networked environment using logical connections to one or more remote computing platforms, such as a remote computing platform 380. The remote computing platform 380 may be a personal computer, a server, a router, a network PC, a peer device or other common network node. The remote computing platform 380 may include many or all of the components described above relative to the computing platform 310. The logical connections to the remote computing platform 380 may include a remote memory storage device 381, a local area network (LAN) 371 and a wide area network (WAN) 373. The logical connections to the remote computing platform 380 may include any other network or logical connection chosen with sound judgment by a person of ordinary skill in the art. When used in a LAN networking environment, the computing platform 310 may be connected to the LAN 371 through a network interface or adapter 370. When used in a WAN networking environment, the computing platform 310 may include a modem device 372 or other means for establishing communications over the WAN 373, such as the Internet, chosen with sound judgment by a person of ordinary skill in the art. The modem device 372, may be and internal or external modem device and may be connected to the system bus 321 via the user input interface 363. In a networked environment, program modules used for operating the automated reconfiguration system 100, or portions thereof, may be stored in the remote memory storage device 381. Additionally, remote application programs 185 for enabling the remote operation or execution of the automated reconfiguration system 100 may be stored on the remote memory storage device 381.

With reference now to FIGS. 2, 3A, and 3B, the automated reconfiguration system 100 may be operatively coupled to communicate with the protective circuit-interrupting devices 62, 72, and 82. In one embodiment, the automated reconfiguration system 100 may be stored in the removable/non-removable, volatile/nonvolatile computer storage media described above. The automated reconfiguration system 100 may be operatively coupled to communicate with the protective circuit-interrupting devices 62, 72, and 82 via either the network interface 370 (when used in a LAN networking environment) or the user input interface 363 (when used in a WAN networking environment). The automated reconfiguration system 100 may be operatively coupled to communicate with the protective circuit-interrupting devices 62, 72, and 82 utilizing any method chosen with sound judgment by a person of ordinary skill in the art. The automated reconfiguration system 100 may direct the autonomous reconfiguration of the first distribution system 26 following the occurrence of a triggering event such as a fault disturbance, a loss-of-voltage, an overload condition, or the manual alteration of select operating parameters of one of the protective circuit-interrupting devices 62, 72, and 82. The automated reconfiguration system 100 may determine information such as the disturbance type, the circuit segment comprising the disturbance, the existing system topology, possible system topologies, and system operating and safety constraints. The automated reconfiguration system 100 may be located at a central or main location within the first distribution network 26. The automated reconfiguration system 100 may operate according to commands contained in computer-executable instructions, or software, stored in removable/non-removable, volatile/nonvolatile computer storage media operatively connected to the computing platform 310.

With reference now to FIGS. 2, 3B, and 5, the automated reconfiguration system 100 may respond differently based, at least partially, on the type of disturbance and the triggering event or resultant action caused by the protective scheme 50. In case of a fault disturbance, the protection scheme 50 may operate such that the protective circuit-interrupting device 62, 72, 82 closest to and upstream of the fault operates thereby isolating the fault from the upstream portion of the first distribution system 26. The portion of the first distribution system 26 located downstream of the protective circuit-interrupting device 62, 72, 82 that operated to isolate the fault remains de-energized, or out of service, until repairs can be affected and the protective circuit-interrupting device 62, 72, 82 can be placed back in service. In one embodiment, the automated reconfiguration system 100 may first detect a fault disturbance at least partially based on a triggering event, wherein the triggering event comprises a breaker or recloser operating to lock-out. The automated reconfiguration system 100 may then analyze the location of the fault disturbance and isolate the faulted circuit segment from all sources of electric supply. The automated reconfiguration system 100 may isolate the faulted circuit segment by opening a protective circuit-interrupting device 62, 72, 82 on all sides of the fault. The automated reconfiguration system 100 may then act to reconfigure the first distribution system 26 by switching any outaged, or non-energized, non-faulted circuit segments to other energized sources of electric supply where allowed by topology. However, even if otherwise unaffected, the non-faulted circuit segments isolated from the fault through the switching actions may remain de-energized due to the unavailability or lack of an alternate source of electric supply.

With reference now to FIGS. 2, 3A, and 3B, in the case of a loss-of-voltage event, the automated reconfiguration system 100 may first detect the loss-of-voltage event upon a triggering event, wherein the triggering event comprises instrumentation at a normally open point determining the loss of voltage. The automated reconfiguration system 100 may first determine if the loss-of-voltage event is a supply issue situation or an undesired open situation. In the case of a supply issue situation wherein the automated reconfiguration system 100 determines that the source of electric supply is de-energized or otherwise unavailable, the automated reconfiguration system 100 may cause the outaged circuit to be switched to another energized source of electric supply. In the case of an undesired open situation, the automated reconfiguration system 100 may cause the downstream protective circuit-interrupting device 62, 72, 82 on the circuit segment comprising the loss of voltage to be opened. The balance of the circuit located downstream of the downstream protective circuit-interrupting device 62, 72, 82 may then be switched to another energized source of electric supply. In the case of an overload condition wherein the automated reconfiguration system 100 determines that the current load exceeds a predetermined threshold, the automated reconfiguration system 100 may perform switching operations to transfer circuit segments and the load served to other energized sources of electric supply with available capacity for the load being switched.

With reference now to FIGS. 3-6, in one embodiment, the automated reconfiguration system 100 may comprise a methodology where, by tabulating the known variables and parameters of the first distribution system 26 and its automated equipment in a specific manner, the automated reconfiguration system 100 can identify, and thereby implement, a desired system reconfiguration for service restoration. The automated reconfiguration system 100 may cause the specifications and data associated with each controlled device located on a circuit path to be mapped into a table 45. The table 45 may comprise an electronic form that is displayed via the display device 191 thereby allowing an operator to perform maintenance and trouble-shooting operations. In one embodiment, the display device 191 may be located in a substation. In another embodiment, the display device 191 may be located in a convention office space. The automated reconfiguration system 100 may cause the specifications and data to be mapped into the table 45 in a sequential manner beginning with a normally open point and proceeding upstream to the transformer serving the circuit path or the source of electric supply (as shown in FIG. 3C). By sequentially stacking the controlled devices, each circuit path can be identified by the controlled devices located in adjacent rows. The delineation of each circuit path at least partially allows for the identification of the circuit path comprising the disturbance by the automated reconfiguration system 100. A circuit path, therefore, comprises a conductive pathway extending from a normally open point to a source of electric supply. Each circuit comprising the first distribution system 26 may have one or more tables 45 associated with it as each circuit may comprise one or more normally open points. In one embodiment, the automatic reconfiguration system 100 may comprise a number of tables 45 that is twice or two times the number of normally open points located within the first distribution system 26.

With reference now to FIG. 3C, each table 45 may comprise a plurality of sets of columns. In one embodiment, each table 45 may comprise a column label row 46, a header row 47, a plurality of device rows 48, and a Totals row 49. The rows comprising each table 45 may be arranged into a first set of columns 110, a second set of columns 120, and a third set of columns 130. The column label row 46 may comprise column identifying information that generally indicates the type of information or data contained within the rows of the corresponding set of columns. The header row 47 may comprise information that generally indicates the individual elements associated with the type of information indicated by the column label row 46. The plurality of device rows 48 may comprise information relating to the specific device to which the information contained within that row pertains. The Totals row 49 may comprise data or information indicating the general condition or status of the corresponding column. Generally, a binary indication may be used to indicate the various statuses and conditions of a specific device associated with a specific row of data or of the status and condition of the circuit path generally. For example, the nominal state of a device may be closed and may be represented in the table with a zero (0), while a one (1) may indicate that the device is open. If a column exists for a binary indication but the corresponding device does not comprise a corresponding parameter, the table may be hard coded with a zero (0) that is not updatable. In addition, the particular definition of zeros (0) and ones (1) shown are not intended to be limiting, and the automated reconfiguration system 100 can utilize any method for distinguishing between such various conditions chosen with sound judgment by a person of ordinary skill in the art.

With continued reference now to FIG. 3C, the first set of columns 110 may comprise a single column and may comprise the left-most column in the table 45. The first set of columns 110 may comprise data relating to device identification. In one embodiment, the column label row 46a of the first set of columns 110 may comprise information indicating the specific circuit path that the table 45 pertains. The header row 47a of the first set of columns 110 may comprise information that indicates that the information and data contained within the first set of columns 110 identifies the specific device to which the data and information contained within that row pertains. For example, the header row 47a may comprise the phrase “Device ID.” The plurality of device rows 48a of the first set of columns 110 may comprise information that identifies the specific device to which the data and information contained within that row pertains. The Totals row 49a of the first set of columns 110 may comprise information that indicates that the information and data contained within the Totals row 49 indicates the general condition or status of the associated circuit path as indicated by the information and data contained in the associated column.

With reference now to FIGS. 3B and 3C, the second set of columns 120 may comprise a first column 121, a second column 122, and a third column 123. The second set of columns 121 may comprise information and data that at least partially allows the automated reconfiguration system 100 to determine the type and location of a disturbance. In one embodiment, the first column 121 may contain information relating to a fault disturbance, the second column 122 may comprise information relating to a loss-of-voltage, and the third column 123 may comprise information relating to an overload condition.

With continued reference now to FIGS. 3B and 3C, the third set of columns 130 may contain data and other information relating to device specifications and operating parameters. The third set of columns 130 may comprise at least a first column 131 that contains a binary value indicating whether the device is in its nominal position. Because the automated reconfiguration system 100 causes the specifications and data associated with each controlled device located on a circuit path to be mapped into a table 45 in a sequential manner beginning with the normally open point and proceeding upstream to the source of electric supply, the nominal position of the first device should be open. Additionally, the nominal position of the remaining devices should be closed. The third set of columns 130 may also comprise an adequate number of additional columns to capture all required device operational parameters.

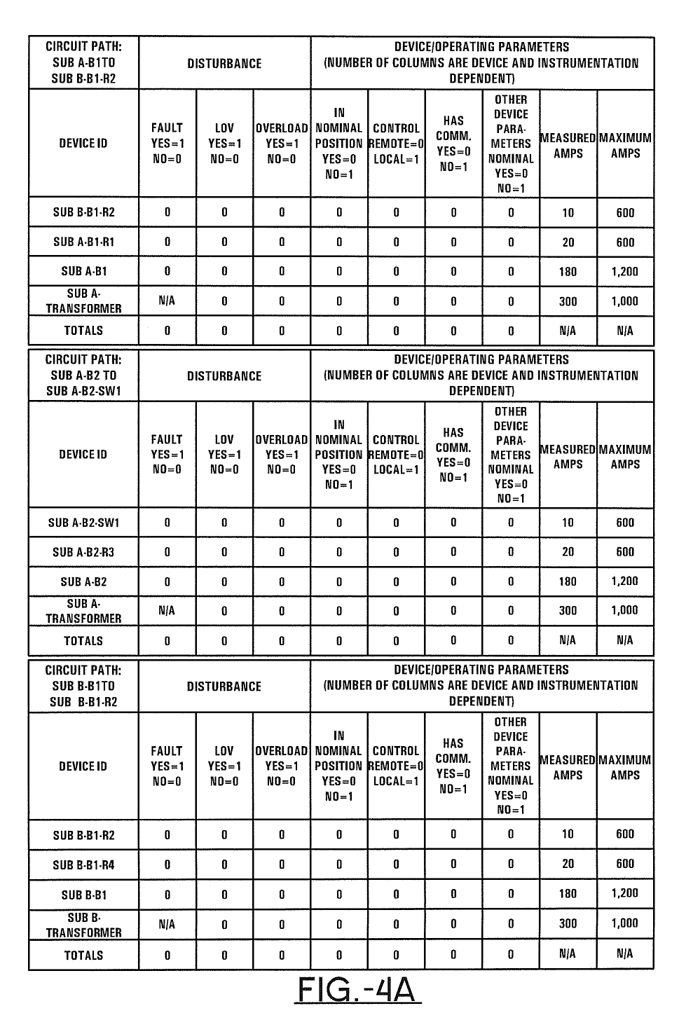

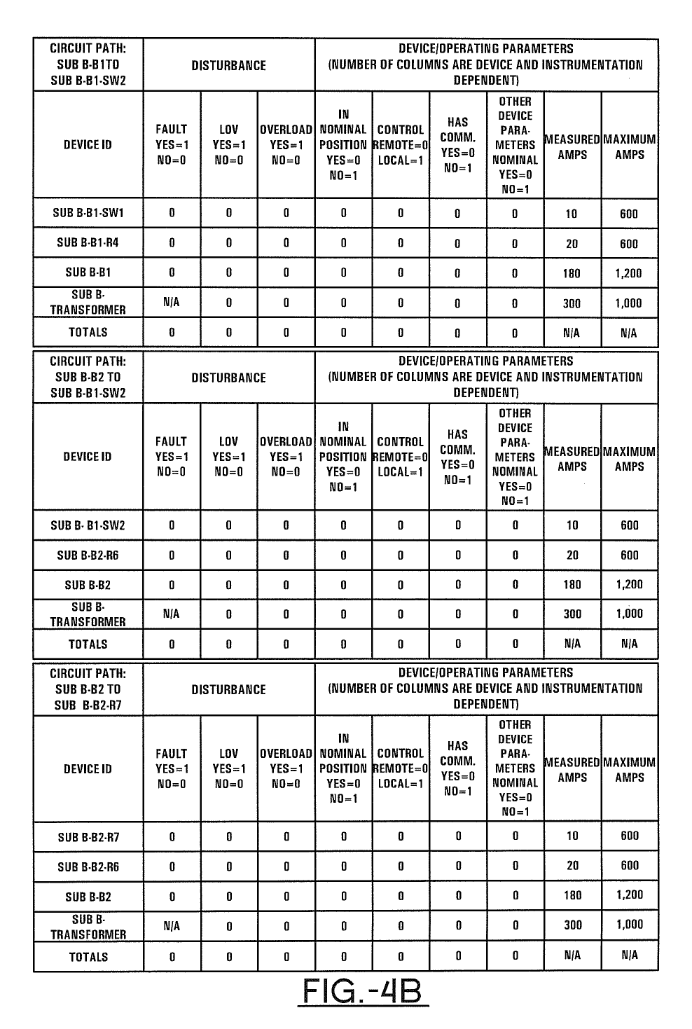

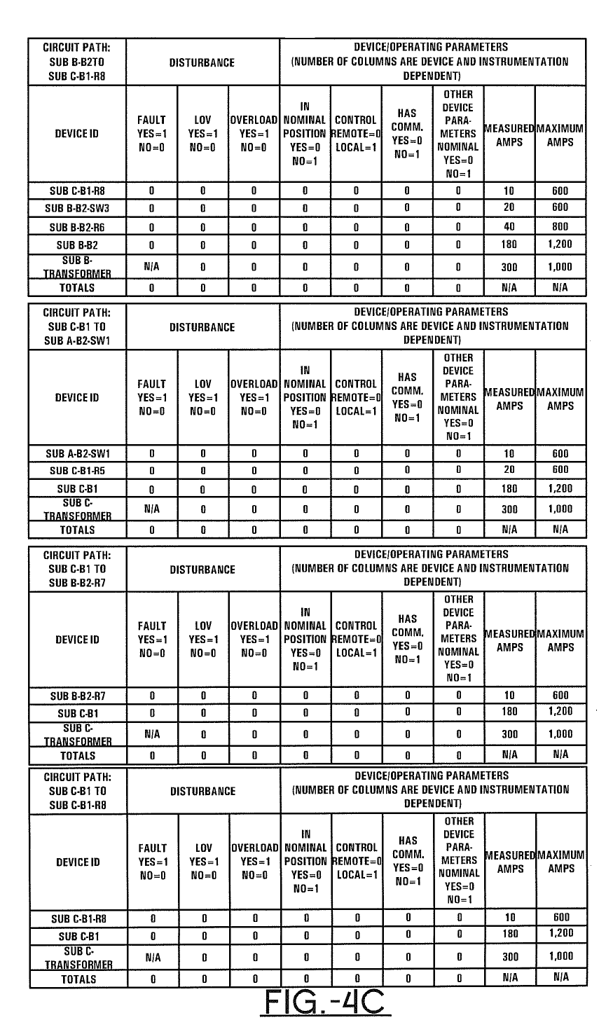

With continued reference now to FIGS. 4A-4C, in one embodiment, the third set of columns 130 may comprise the at least a first column 131, a second column 132, a third column 133, a fourth column 134, a fifth column 135, and a sixth column 136. The second column 132 may comprise information and data indicating whether the device can be controlled remotely. The third column 133 may comprise information and data indicating whether the device is currently in communication with the master control 102. The fourth column 134 may comprise information and data indicating the status of other device parameters. The fifth column 135 may comprise information and data indicating the measured amperage through the device. The sixth column 136 may comprise information and data indicating the maximum amperage for the device. The number of columns comprising the third set of columns 130 may directly relate to the specific type of devices located within the first distribution system 26. The third set of columns 130 may comprise any number of columns chosen with sound judgment by a person of ordinary skill in the art.

With reference now to FIGS. 3-6, the method for automated isolation of a disturbance will generally be described. In one embodiment, the automated reconfiguration system 100 may be initiated by a triggering event, such as a lock-out, a loss of voltage at the normally open point, an overload alarm indicating an overload condition, or when select operating parameters on a device are manually changed. Upon determining that a triggering event has occurred, the automated reconfiguration system 100 may scan the first distribution system 26 to determine the general condition and state of the controlled devices while contemporaneously updating the associated tables 45. If a non-nominal state is detected during the scanning of the first distribution system 26 the appropriate cell of the table 45 is populated with a one (1). If a nominal state is detected, the cell is populated with a zero (0). Column totals of binary states then provide a quick analysis of reconfiguration options, which are different for different trigger events. Following a trigger event, and the subsequent update of the table(s) 45, one or more columns of the second set of columns 120 will indicate a value greater than zero (0) in its respective Totals row 49. By scanning the Totals row 49 of the second set of columns 120 from left to right for the first non-zero value, the automated reconfiguration system 100 can determine the type of disturbance and the reconfiguration parameters to be utilized in reconfiguring the first distribution system 26.

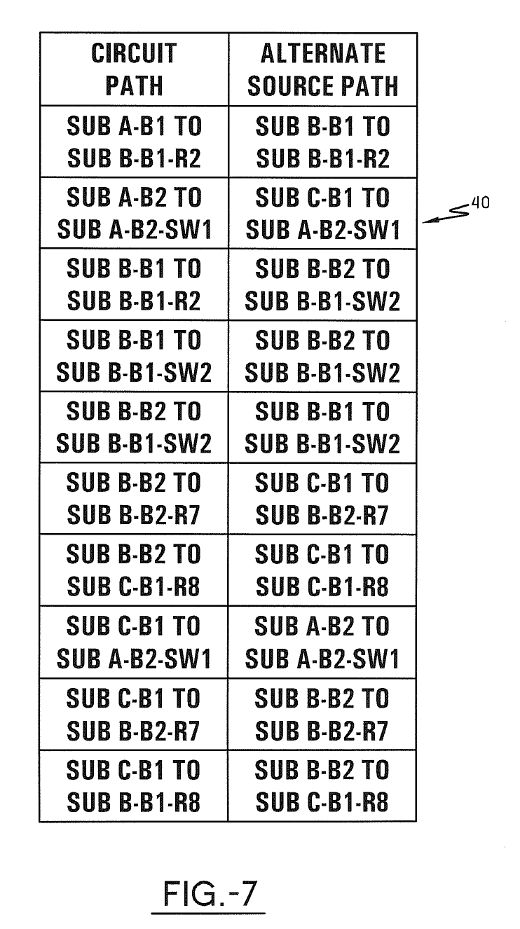

With reference now to FIGS. 3-7, in one embodiment, an alternate source of electric supply is associated with each circuit path. When a disturbance is indicated on one circuit path, the automated reconfiguration system 100 scans an alternate source table 40 (as shown in FIG. 7). The alternate source table 40 may provide an alternate source path to an alternate source of electric supply for each circuit path. The alternate source table 40 may be utilized to determine the table 45 to be analyzed in determining the availability of the alternate source of electric supply. If the Totals row 49 of the table 45 associated with the alternate source of electric supply contains only zero (0) values, the automated reconfiguration system 100 further analyzes the table 45 to determine loading conditions. If the automated reconfiguration system 100 determines that the loading conditions permit the transfer of load to the alternate circuit path then the automated reconfiguration system 100 causes the first distribution system 26 to be reconfigured accordingly. If the automated reconfiguration system 100 determines that any value in the Totals row 49 of the table 45 associated with the alternate source of electric supply is greater than zero (0), the automated reconfiguration system 100 determines that the alternate source of electric supply is unavailable. The automated reconfiguration system 100 may then analyze the alternate source table 40 to determine if a second alternate source of electric supply is associated with the circuit path comprising the disturbance. If the automated reconfiguration system 100 determines that a second alternate source of electric supply is associated with the circuit path comprising the disturbance, the automated reconfiguration system 100 determines if the second alternate source of electric supply is available as described with respect to the first alternate source of electric supply described above. If all available sources of electric supply associated with the circuit path comprise non-zero values in the Totals row 49 or are otherwise determined to be unavailable, then the method is terminated without the automated reconfiguration system 100 performing any switching or reconfiguration operations.

With continued reference now to FIGS. 3-6, the method of the present invention will now be described with respect to one possible exemplary embodiment of the first distribution system 26 as shown in FIG. 3A. The first distribution system 26 comprises a first substation A, a second substation B, and a third substation C. The first distribution system 26 also comprises six circuits (five of which are part of the protection scheme), a first breaker SubA-B1, a second breaker SubA-B2, a third breaker SubB-B1, and a fourth breaker SubB-B2, SubC-B1. The first distribution system 26 comprises eleven line devices of which five are operated in a normally open configuration and therefore comprise a normally open point. FIG. 3A shows the core system topology and devices all in nominal configurations but omits non-pertinent equipment for clarity. Each circuit path from a breaker to a normally open point is mapped into a table 45 and, as there are five normally open points, there will be ten tables 45. FIGS. 4A, 4B, and 4C show the ten circuit path tables for the first distribution system 26 in its nominal state.

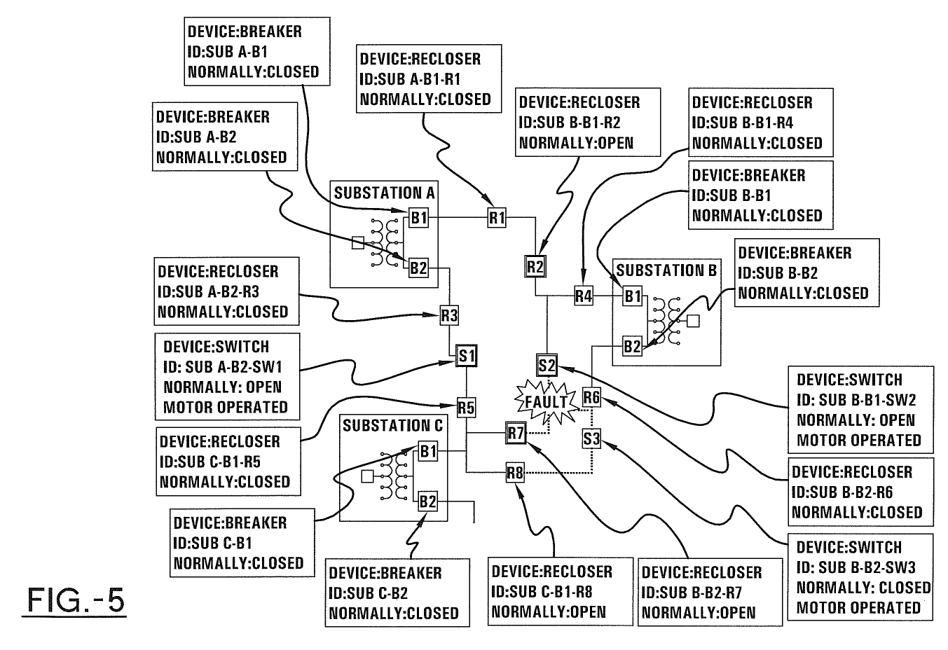

FIG. 5 shows a fault disturbance located on the first distribution system 26 in the circuit segment bounded by switch SubB-B1-SW2, recloser SubB-B2-R7, switch SubB-B2-SW3, and recloser SubB-B2-R6. Fault current will first pass through the breaker SubB-B2 then the recloser SubB-B2-R6. Therefore, as the recloser SubB-B2-R6 is the nearest upstream protective device, the recloser SubB-B2-R6 should operate to lock-out thereby causing the occurrence of a triggering event.

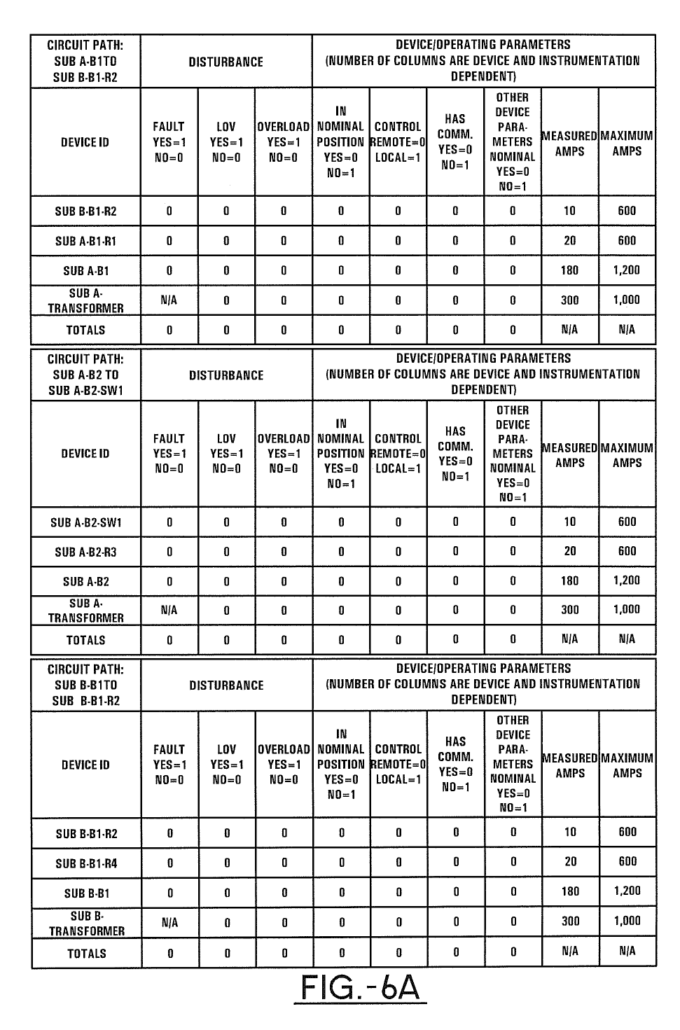

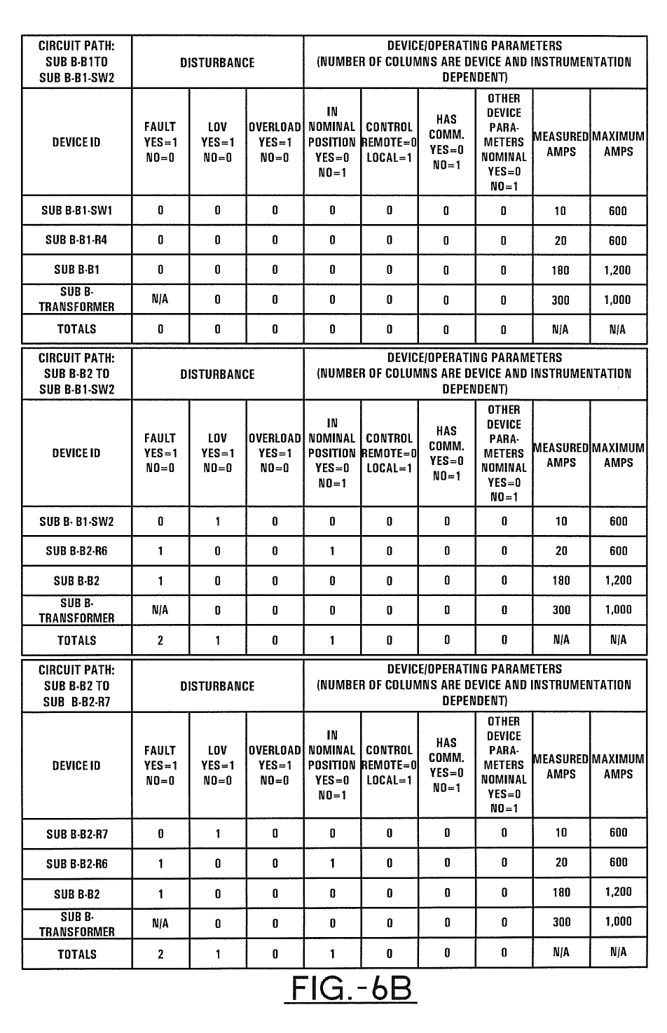

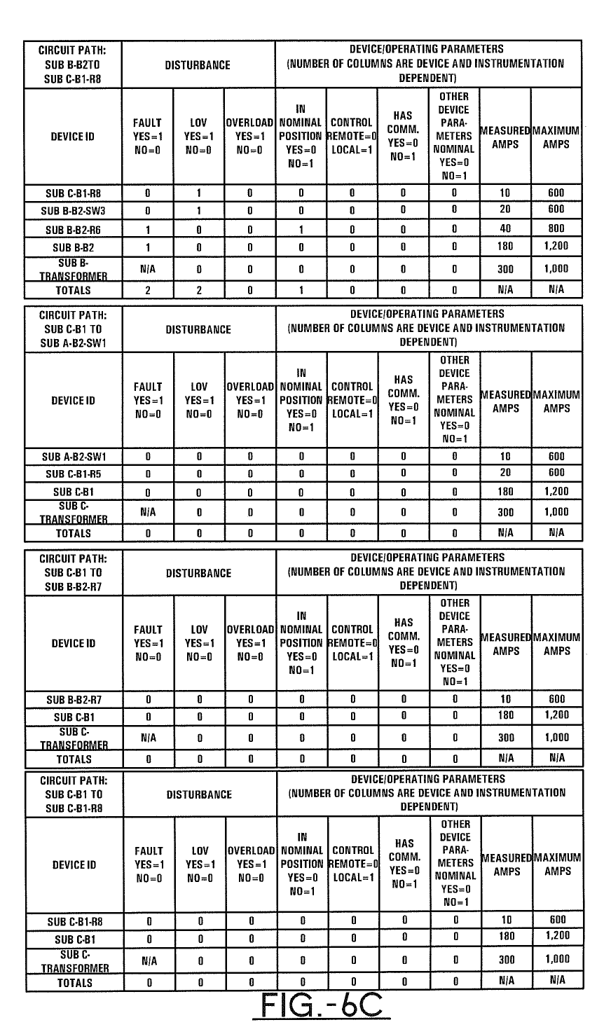

FIGS. 6A-6C show the ten tables 45, post disturbance, after the fault protection has had an opportunity to completely operate. The automatic reconfiguration system 100 is triggered or initiated by the lockout condition at recloser SubB-B2-R6. The determination of the triggering event causes the master control 102 to scan the first distribution system 26 and to update the tables 45 accordingly. Upon the updating of the tables 45, the automated reconfiguration system 100 scans the individual cells comprising the Totals row 49 of the second set of columns 120 for any non-zero entries. In accordance with this example, the automated reconfiguration system 100 determines that table SubB-B2 to SubB-B1-SW2, table SubB-B2 to SubB-B2-R7, and table SubB-B2 to SubC-B1-R8 comprise non-zero entries in the Totals row 49 of the respective second set of columns 120.

With reference now to FIG. 7 and table SubB-B2 to SubB-B1-SW2, the automated reconfiguration system 100 scans the table SubB-B2 to SubB-B1-SW2 from left to right and determines that the first non-zero value in the Totals row 49 is located in the first column 121 of the second set of columns 120. Therefore, the automated reconfiguration system 100 determines that the triggering event resulted from a fault. Scanning down the first column 121 of the second set of columns 120, the automated reconfiguration system 100 determines that the first change of state from a zero (0) to a one (1) identifies the fault location on this circuit path, which, for purposes of this example, occurred between the normally open point, switch SubB-B1-SW2, and recloser SubB-B2-R6. The fault reconfiguration parameters first require the automated reconfiguration system 100 to cause the devices positioned on either side of the fault to be opened and then the normally open device to be closed. In accordance with the present example, the automated reconfiguration system 100, therefore, causes the recloser SubB-B2-R6 to be opened. Because the other end of the faulted section of circuit, on this circuit path, is the normally open point, switch SubB-B1-SW2. Because a fault is isolated by opening the devices on the circuit path adjacent to the fault, the opening of the recloser SubB-B2-R6 in conjunction with the position of the normally open point, switch SubB-B1-SW2, caused the fault to be isolated. The automated reconfiguration system 100 then determines the availability of an alternate source of electric supply. If the automated reconfiguration system 100 determines that an alternate source of electricity can be utilized the device at the normally open point is closed. In one embodiment, the automated reconfiguration system 100 comprises an associated alternate source table 44. The automated reconfiguration system 100 may analyze the associated alternate source table 44 to determine the existence of any associated alternate sources of electric supply for a specific circuit path. For purposes of the present example, the device at the normally open point comprises a device that is required to remain open in order to isolate the fault and therefore it cannot be closed and the automated reconfiguration system 100 determines that this alternate source is not available.

With reference now to FIG. 7 and table SubB-B2 to SubB-B2-R7, the automated reconfiguration system 100 scans the table SubB-B2 to SubB-B2-R7 to be scanned from left to right and determines that the first non-zero value in the Totals row 49 of the second set of columns 120 is in the first column 121. Therefore, the automated reconfiguration system 100 determines that type of disturbance is a fault. The automated reconfiguration system 100 scans down the first column 121 and determines that the first change of state from a zero (0) to a one (1) indicates that the fault location on this circuit path is between the normally open device, recloser SubB-B2-R7, and the recloser SubB-B2-R6. In a manner similar to that described above, the automated reconfiguration system 100 determines that the alternate source associated with this circuit path is not available.

With reference now to FIG. 7 and table SubB-B2 to SubC-B1-R8, the automated reconfiguration system 100 scans the table SubB-B2 to SubC-B1-R8 from left to right and determines that the first non-zero value in the Totals row 49 of the second set of columns 120 is in the first column 121. Therefore, the automated reconfiguration system 100 determines the type of disturbance to be a fault. The automated reconfiguration system 100 scans down the first column 121 and determines that the first change of state from a zero (0) to a one (1) occurs between the switch SubB-B2-SW3 and the recloser SubB-B2-R6. The automated reconfiguration system 100 determines that the switch SubB-B2-SW3 is not a normally open device and therefore is not required to remain open in order to isolate the fault. The automated reconfiguration system 100 then analyzes the associated alternate source table 44 and determines the alternate source circuit path to correspond to table SubC-B1 to SubC-B1-R8.

With reference now to table SubC-B1 to SubC-B1-R8, the automated reconfiguration system 100 scans the second and third sets of columns 120, 130 of the table SubC-B1 to SubC-B1-R8 to determine the availability of the alternate source. If the automated reconfiguration system 100 determines that there is a non-zero value (excluding N/A) in the Totals row 49 of either the second or the third sets of columns 123, 130, the automated reconfiguration system 100 determines that the alternate source is not available. Additionally, if the automated reconfiguration system 100 determines that the measured amperage at the switch SubB-B2-SW3 exceeds the difference between the maximum and the measured amperage on the SubC-Transformer, the automated reconfiguration system 100 determines that this alternate source can not accommodate the load and therefore, is not available.

With continued reference now to table SubC-B1 to SubC-B1-R8, if the automated reconfiguration system 100 determines that neither of the conditions stated above are true, then the automated reconfiguration system 100 causes the switch SubB-B2-sw3 to be opened, confirms that the switch SubB-B2-SW3 is open, closes the normally open point, recloser SubC-B1-R8, confirms that the normally open point, recloser SubC-B1-R8 is closed; and then causes the process to be terminated. This reconfiguration automatically restores service to those consumers served from the system between the recloser SubC-B1-R8 and the switch SubB-B2-SW3.

When the first distribution system 26 is physically altered, the underlying tables 45 of the automatic reconfiguration system 100 can be modified by changing individual tables, deleting existing tables or adding new tables as required by the physical alteration of the first distribution system 26. The automatic reconfiguration system 100 is therefore scalable for use with any automated protection scheme 50.

The embodiments have been described, hereinabove. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

Having thus described the invention, it is now claimed:

What is claimed is:

1. A method for analyzing system reconfiguration for automated isolation of disturbances to a power distribution system comprising the steps of:
(a) providing an automated reconfiguration system for analyzing system reconfiguration for automated isolation of disturbances to a power distribution system;
(b) detecting a triggering event, wherein the triggering event indicates a disturbance within the power distribution system;
(c) scanning at least a first circuit of the power distribution system to update a predetermined set of data relating to a plurality of controlled devices located within the first circuit, wherein the first circuit comprises at least a first circuit path;
(d) autonomously updating at least a first table, wherein the first table comprises data associated with the first circuit path and the first table comprises a plurality of sets of rows, wherein the plurality of sets of rows are arranged to form a plurality of sets of columns, wherein each set of columns comprises at least a first set of rows and a second set of rows,
wherein the first set of rows comprises a plurality of device rows and each of the plurality of device rows comprise data relating to one of the controlled devices located on the first circuit path of the first circuit and the plurality of device rows are arranged in a sequential manner beginning with a normally open point and proceeding upstream to a source of supply, wherein a first binary indicator is used to indicate the status of each of the controlled devices;
wherein the second set of rows comprises a single row comprising data indicating the status of the first circuit path and a second binary indicator is used to indicate the status of the first circuit path;
(e) determining a type of disturbance comprised by the disturbance, wherein the type of disturbance is at least partially determined by analyzing the first table;
(f) determining a circuit segment comprising the disturbance wherein the circuit segment comprising the disturbance is at least partially determined by analyzing the first table;
(g) isolating the disturbance;
(h) determining a non-energized non-faulted portion of the circuit segment;
(i) identifying an alternate source of electric supply;
(j) terminating the method if the alternate source of electric supply is determined to be unavailable to energize the non-energized non-faulted portion of the circuit segment; and,
(k) reconfiguring the power distribution system if the alternate source of electric supply is determined to be available, wherein the power distribution system is reconfigured such that the non-energized non-faulted portion of the circuit segment is energized by the alternate source of electric supply.

2. The method of claim 1, wherein step (d) further comprises the step of:
autonomously updating the first table, wherein the first table comprises a first set of columns comprising a first column, a second column, and a third column, wherein the first column can be analyzed to indicate the type of disturbance as a fault disturbance, the second column can be analyzed to indicate the type of disturbance as a loss-of-voltage, and the third column can be analyzed to indicate the type of disturbance as an overload condition.

3. The method of claim 1, wherein step (d) further comprises the step of:
autonomously updating the first table, wherein the plurality of sets of columns of the first table comprises a first set of columns and a second set of columns,
wherein the first set of columns comprises a first column, a second column, and a third column, wherein the first column can be analyzed to indicate the type of disturbance as a fault disturbance, the second column can be analyzed to indicate the type of disturbance as a loss-of-voltage, and the third column can be analyzed to indicate the type of disturbance as an overload condition; and,
the second set of columns comprises at least a first column that comprises a first binary indicator indicating whether each of the plurality of controlled devices comprise a nominal position, wherein the nominal position of the normally open point is open and the nominal position of the remaining devices comprising the plurality of controlled devices is closed.

4. The method of claim 1, wherein the plurality of sets of columns comprises a first set of columns, wherein step (e) further comprises the step of:
scanning the second set of rows of the first set of columns for a non-zero binary indicator.

5. The method of claim 1, wherein the plurality of sets of columns comprises a first set of columns, wherein step (f) further comprises the step of:
scanning down the first set of columns.

6. The method of claim 5, wherein the step of, scanning down the first set of columns, further comprises the step of:
identifying the location of the disturbance at a first change in the first binary indicator.

7. The method of claim 1, wherein step (e) further comprises the step of:
determining the disturbance to comprise a fault disturbance; and,
step (g) further comprises the step of:
opening the controlled devices located on either side of the fault disturbance.

8. The method of claim 1, wherein the automated reconfiguration system comprises a display device, wherein step (a) further comprises the step of:
displaying the first table, wherein the display device at least partially allows an operator to perform maintenance and trouble-shooting operations.

9. The method of claim 1, wherein the automated reconfiguration system comprises a computing platform, wherein step (a) further comprises the step of:
implementing the method for analyzing system reconfiguration for automated isolation of disturbances to a power distribution system at least partially utilizing the computing platform.

10. A first computing platform for implementing the method of claim 1, wherein the computing platform implements the method of claim 1 in response to the execution of a computer-executable instruction.

11. The first computing platform of claim 10, wherein the first computing platform operates in a networked environment using a logical connection to a second computing platform.

12. The first computing platform of claim 11, wherein the logical connection comprises a wide area network.

13. The first computing platform of claim 11, wherein the logical connection comprises a local area network.

14. The first computing platform of claim 11, wherein the logical connection comprises the internet.

15. The first computing platform of claim 10, wherein the first computing platform further comprises:
a display device for displaying the first table, wherein the display device at least partially allows an operator to perform maintenance and trouble-shooting operations.

16. The method of claim 1, wherein step (j) further comprises the step of:
analyzing a second table to determine a second circuit path and an associated third table; and,
analyzing the third table to determine if the alternate source of electric supply is available.

17. A computer-readable storage medium having computer-executable instructions to perform a method for analyzing system reconfiguration for automated isolation of disturbances to a power distribution system, wherein the method comprises the steps of:
(a) detecting a triggering event, wherein the triggering event indicates a disturbance within the power distribution system;
(b) scanning at least a first circuit of the power distribution system to update a predetermined set of data relating to a plurality of controlled devices located within the first circuit, wherein the first circuit comprises at least a first circuit path;
(c) autonomously updating at least a first table, wherein the first table comprises data associated with the first circuit path and the first table comprises a plurality of sets of rows, wherein the plurality of sets of rows are arranged to form a plurality of sets of columns, wherein each set of columns comprises at least a first set of rows and a second set of rows,
wherein the first set of rows comprises a plurality of device rows and each of the plurality of device rows comprise data relating to one of the controlled devices located on the first circuit path of the first circuit and the plurality of device rows are arranged in a sequential manner beginning with a normally open point and proceeding upstream to a source of supply, wherein a first binary indicator is used to indicate the status of each of the controlled devices;
wherein the second set of rows comprises a single row comprising data indicating the status of the first circuit path and a second binary indicator is used to indicate the status of the first circuit path;
(d) determining a type of disturbance comprised by the disturbance, wherein the type of disturbance is at least partially determined by analyzing the first table;
(e) determining a circuit segment comprising the disturbance wherein the circuit segment comprising the disturbance is at least partially determined by analyzing the first table;
(f) isolating the disturbance;
(g) determining a non-energized non-faulted portion of the circuit segment;
(h) identifying an alternate source of electric supply;
(i) terminating the method if the alternate source of electric supply is determined to be unavailable to energize the non-energized non-faulted portion of the circuit segment; and,
(j) reconfiguring the power distribution system if the alternate source of electric supply is determined to be available, wherein the power distribution system is reconfigured such that the non-energized non-faulted portion of the circuit segment is energized by the alternate source of electric supply.

18. The computer-readable storage medium of claim 17, wherein step (c) of the method further comprises the step of:
autonomously updating the first table, wherein the first table comprises a first set of columns comprising a first column, a second column, and a third column, wherein the first column can be analyzed to indicate the type of disturbance as a fault disturbance, the second column can be analyzed to indicate the type of disturbance as a loss-of-voltage, and the third column can be analyzed to indicate the type of disturbance as an overload condition.

19. The computer-readable storage medium of claim 17, wherein step (c) of the method further comprises the step of:
autonomously updating the first table, wherein the plurality of sets of columns of the first table comprises a first set of columns and a second set of columns,
wherein the first set of columns comprises a first column, a second column, and a third column, wherein the first column can be analyzed to indicate the type of disturbance as a fault disturbance, the second column can be analyzed to indicate the type of disturbance as a loss-of-voltage, and the third column can be analyzed to indicate the type of disturbance as an overload condition; and,
the second set of columns comprises at least a first column that comprises a first binary indicator indicating whether each of the plurality of controlled devices comprise a nominal position, wherein the nominal position of the normally open point is open and the nominal position of the remaining devices comprising the plurality of controlled devices is closed.

20. The computer-readable storage medium of claim 17, wherein step (d) of the method further comprises the step of:
determining the disturbance to comprise a fault disturbance; and,
step (f) further comprises the step of:
opening the controlled devices located on either side of the fault disturbance.
